(19) United States
(12) Patent Application Publication
(10) Pub. No.: US 2008/0117478 A1
(43) Pub. Date: May 22, 2008

(54) FACSIMILE APPARATUS, AND CONTROL METHOD, PROGRAM, AND STORAGE MEDIUM THEREFOR

(75) Inventor: Akio Suzuki, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/941,668

(22) Filed: Nov. 16, 2007

(30) Foreign Application Priority Data
Nov. 22, 2006 (JP) 2006-315451

(51) Int. Cl. H04N 1/40

(52) U.S. Cl. 358/468

(57) ABSTRACT

A facsimile apparatus can execute at least one of a first facsimile communication which is executed via a first communication path including a public line and a second facsimile communication executed via a second communication path that does not include the public line. Limit information indicating a number of communications which can be executed in parallel, the communications including at least one of the first facsimile communication and the second facsimile communication is stored and managed. An initiation request of a new facsimile communication is accepted when a facsimile communication is executed by using at least one of the first communication path and the second communication path. It is determined whether a communication path used for the new facsimile communication is the first communication path or the second communication path.

### BACKGROUND OF THE INVENTION

1. Field of the Invention

The present invention relates to a facsimile apparatus capable of performing a plurality of facsimile communications in parallel.

2. Description of the Related Art

Up to now, there are proposed an apparatus having a G3 facsimile communication function which is executed via a public line while following ITU-T Recommendation T.30 (hereinafter referred to as T.30 communication) and an apparatus having a store-and-forward facsimile communication function which is executed via the Internet while following ITU-T Recommendation T.37. Then, as described in Japanese Patent Laid-Open No. 2002-44357, an apparatus having a real-time Internet facsimile communication function which is executed via a LAN or the Internet while following ITU-T Recommendation T.38 (hereinafter referred to as T.38 communication) has been also developed for performing a communication in real time by using the Internet in recent years. According to this T.38 communication, via a gateway (GW) apparatus complying with ITU-T Recommendation T.38 (hereinafter referred to as T.38 GW), it is becoming possible to perform a communication with a T.30 communication capable apparatus connected to the public line.

It is noted that the T.30 communication capable apparatus refers to an analog terminal apparatus such as a telephone or a facsimile apparatus which can be connected to the public line in this case. On the other hand, a T.38 communication capable apparatus refers to a digital terminal apparatus which performs a packet communication complying with Internet Protocol and which can be connected to a data communication network such as a local area network (LAN) or the Internet.

Incidentally, in a system for performing the T.38 or T.30 communication through the connection to the above-described various networks, a communication logical channel allows a large number of connections. In other words, it is possible to execute a plurality of facsimile communications in parallel. However, if more than a certain number of facsimile communications are executed in parallel, a system load becomes large, and there is a problem that a processing may not be performed in time in an apparatus on a transmission side or a reception side. In particular, if an encoding processing on the transmission side or a decoding processing on the reception side is delayed, there is a possibility that a delay of a facsimile signal may be generated. If a predetermined timer value is exceeded, the communication is disconnected.

In addition, in a case where a communication via the T.38 GW or PSTN to the T.30 communication capable apparatus is performed, there is a problem that the processing is not performed in time and the communication cannot be performed. That is, in particular, in the case of the T.30 communication, the above-described timer value is strictly prescribed, and there is a possibility that the communication may be frequently disconnected.

### SUMMARY OF THE INVENTION

The present invention provides a system in which even when a plurality of facsimile communications are executed in parallel, the respective facsimile communications can be executed in parallel with certainty by previously setting the number of facsimile communications which can be executed in parallel.

That is, according to an aspect of the present invention, there is provided a facsimile apparatus, including: a facsimile communication unit configured to execute at least one of a first facsimile communication which is executed via a first communication path including a public line and a second facsimile communication which is executed via a second communication path that does not include the public line; a management unit configured to manage limit information indicating a number of communications which can be executed in parallel, the communications including at least one of the first facsimile communication and the second facsimile communication; an accepting unit configured to accept an initiation request of a new facsimile communication when a facsimile communication is executed by using at least one of the first communication path and the second communication path; a determination unit configured to determine whether a communication path used for the new facsimile communication is the first communication path or the second communication path; and a control unit configured to control the facsimile communication unit by determining whether or not to initiate the new facsimile communication based on the limit information managed by the management unit and a determination result of the determination unit.

Also, according to another aspect of the present invention, there is provided a control method for a facsimile apparatus which is capable of executing at least one of a first facsimile communication which is executed via a first communication path including a public line and a second facsimile communication which is executed via a second communication path that does not include the public line, the control method including: storing limit information in a storage medium and managing the limit information indicating a number of communications which can be executed in parallel, the communications including at least one of the first facsimile communication and the second facsimile communication; accepting an initiation request of a new facsimile communication when a facsimile communication is executed by using at least one of the first communication path and the second communication path; determining whether a communication path used for the new facsimile communication is the first communication path or the second communication path; and controlling an execution of the facsimile communication by determining whether or not to initiate the new facsimile communication based on the managed limit information and a result of the determination.

In addition, according to another aspect of the present invention, there is provided a computer readable storage medium storing a program for instructing a computer to execute the above-described control method.

Moreover, according to another aspect of the present invention, there is provided a program for instructing a computer to execute the above-described control.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principle of the invention.

FIG. 1 is a block diagram of a data communication system example to which a data communication apparatus according to a first exemplary embodiment of the present invention is applied.

FIG. 2 is a block diagram for describing a configuration of an image forming apparatus to which the data communication apparatus according to the present embodiment is applied.

FIGS. 3A to 3C are diagrams for describing the configuration of the image forming apparatus to which the data communication apparatus according to the present embodiment is applied.

FIG. 4 illustrates a first session example in the data communication apparatus according to the present embodiment.

FIG. 5 illustrates a second session example in the data communication apparatus according to the present embodiment.

FIG. 6 is a flowchart illustrating a first communication processing procedure in the data communication apparatus according to the present embodiment.

FIG. 7 is a diagram for describing a display transit of a user interface (I/F) screen of a user mode displayed on an operation panel unit illustrated in FIG. 2.

FIG. 8 is a diagram for describing a first communication phase example in the image forming apparatus to which the data communication apparatus according to the present embodiment is applied.

FIG. 9 is a diagram for describing a second communication phase example in the image forming apparatus to which the data communication apparatus according to the present embodiment is applied.

FIG. 10 is a diagram for describing a third communication phase example in the image forming apparatus to which the data communication apparatus according to the present embodiment is applied.

FIG. 11 is a diagram for describing a fourth communication phase example in the image forming apparatus to which the data communication apparatus according to the present embodiment is applied.

FIG. 12 is a diagram for describing a memory map of a storage medium storing various data processing programs which can be read by the data communication apparatus according to the present embodiment.

### DESCRIPTION OF THE EMBODIMENTS

Hereinafter, embodiments of the present invention will be described in detail with reference to the drawings.

### <Description of the System Configuration>

### First Exemplary Embodiment

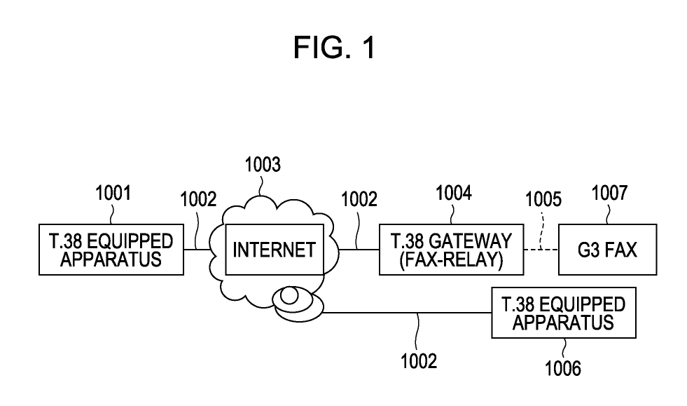

FIG. 1 is a block diagram of a data communication system example to which a data communication apparatus according to a first exemplary embodiment of the present invention is applied. The present example is a system example in which an image forming apparatus including the data communication apparatus can perform a direct communication with a T.38 communication capable facsimile apparatus via the Internet or a communication with a T.30 communication capable facsimile apparatus via a T.38 GW.

In FIG. 1, facsimile apparatuses 1001 and 1006 can cope with, for example, a T.38 communication. The facsimile apparatuses 1001 and 1006 are connected to each other via an Internet 1003 and a network 1002 so that the communication can be performed.

Also, the facsimile apparatus 1001 is configured to be able to communicate with a T.30 communication capable facsimile apparatus 1007 via the network 1002, the Internet 1003, a T.38 GW 1004, and an analog public line 1005.

The T.38 GW 1004 executes a T.30 communication with the G3 FAX 1007 which is connected via the analog public line 1005.

The T.38 communication capable facsimile apparatuses 1001 and 1006 execute the T.38 communication while being connected via the Internet 1003.

In addition, the facsimile apparatus 1001 and the facsimile apparatus 1007 are connected to each other via the network 1002, the Internet 1003, and the T.38 GW 1004 and execute the T.30 communication.

At this time, the T.38 communication is executed between the facsimile apparatus 1001 and the T.38 GW 1004.

Also, the T.38 GW 1004 is connected to the facsimile apparatus 1007 via the analog public line 1005 to execute the T.30 communication.

The facsimile apparatus 1001 is configured to be able to establish a plurality of communication sessions via the Internet 1003. Then, it is possible to execute the facsimile communication in parallel with the plurality of T.38 communication capable facsimile apparatuses and T.30 communication capable facsimile apparatuses via the Internet 1003. It is noted that although not illustrated in the drawing, a data communication apparatus having the similar function of the facsimile apparatus 1006 or the facsimile apparatus 1007 is further provided on the Internet 1003 or the public line 1005.

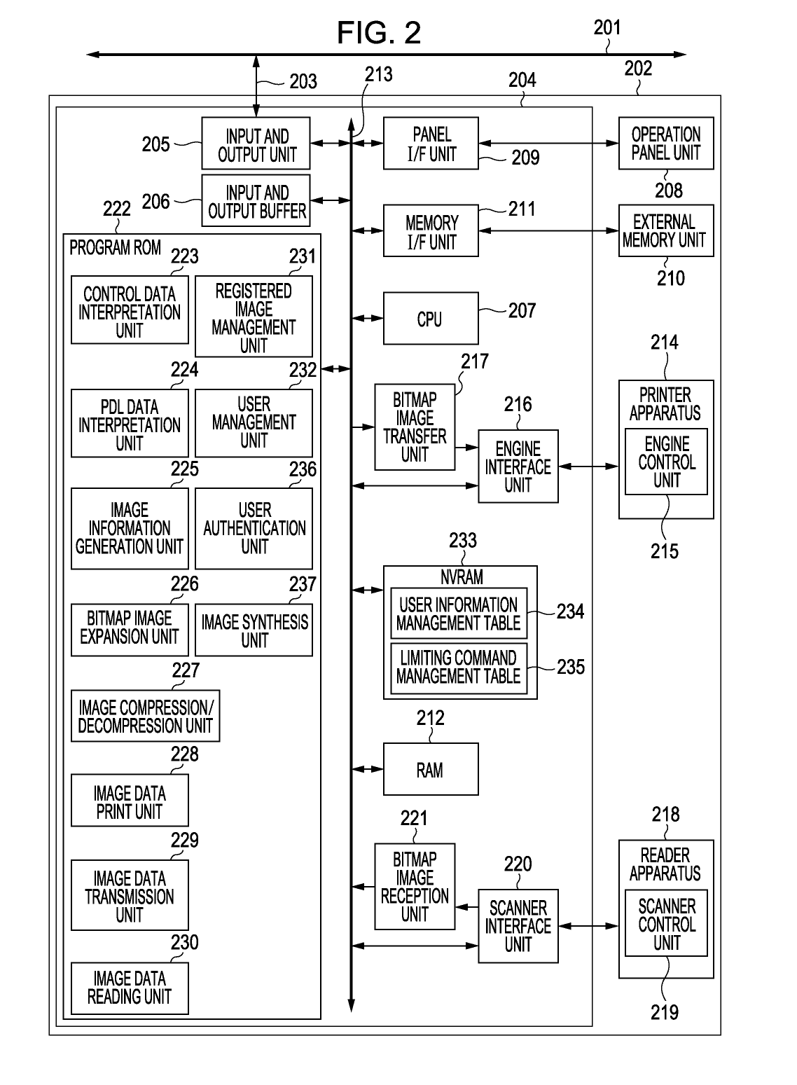

FIG. 2 is a block diagram for describing a configuration of an image forming apparatus to which the data communication apparatus according to the present embodiment is applied. Also, such a configuration is adopted that a SIP server which will be described later, the T.38 GW, the T.30 communication capable facsimile apparatus, the T.38 communication capable facsimile apparatus, and the like can be connected to a network 201. It is noted that according to the present embodiment, a case in which the data communication apparatus is applied to the image forming apparatus is applied will be described, but a case in which the data communication apparatus is applied to a computer apparatus is applied may also be employed.

It is noted that according to the present embodiment, the T.30 communication capable facsimile apparatus 1007 is used as an example of a first data communication apparatus which can be connected to the Internet 1003 via the T.38 GW 1004. Also, the T.38 communication capable facsimile apparatus 1006 is used as an example of a second data communication apparatus which can be connected to the Internet 1003. Then, the facsimile apparatus 1001 which is the data communication apparatus example executes the T.38 communications with the facsimile apparatus 1007 or the facsimile apparatus 1006 via the Internet 1003 to transmit and receive the data.

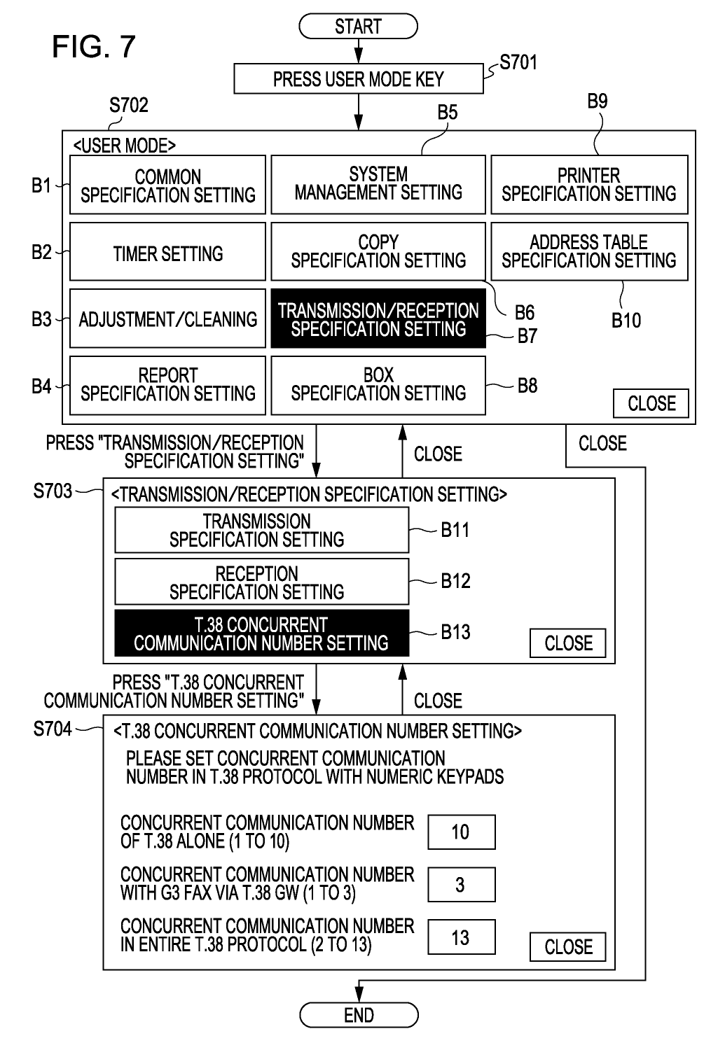

Also, in the facsimile apparatus 1001, through an operation screen illustrated in FIG. 7 which will be described later, via the T.38 GW 1004, it is possible to set a first concurrent communication limit number by which the T.38 communications are executed concurrently with the facsimile apparatus 1007 that can be connected to the Internet 1003. Similarly, it is possible to set a second concurrent communication limit number by which the T.38 communications are executed concurrently with the facsimile apparatus 1006 that can be connected to the Internet 1003.

Furthermore, it is possible to individually set a third concurrent communication limit number by which the facsimile apparatus 1007 and the facsimile apparatus 1006 concurrently execute the T.38 communications.

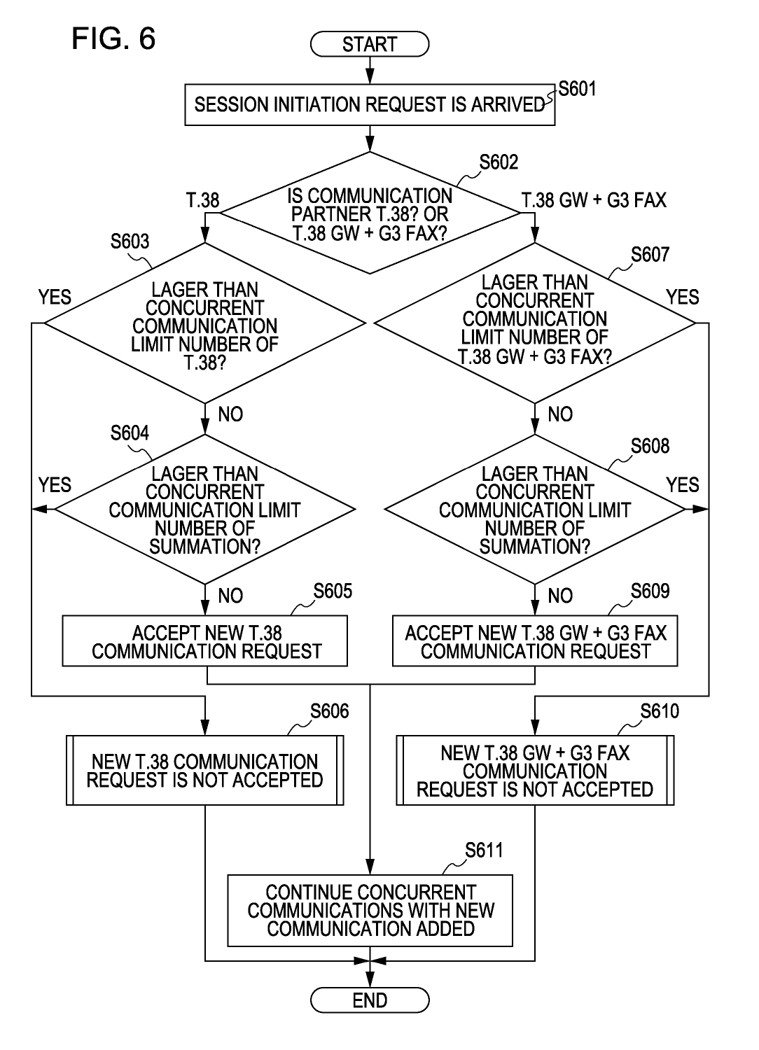

A CPU 207 which will be described later determines whether a destination terminal which requests a communication initiation is the first or second data communication apparatus in accordance with a control procedure illustrated in FIG. 6. Then, in a case where the communication request is received from the determined first or second data communication apparatus, the CPU 207 determines whether the set first to third concurrent communication limit numbers are exceeded.

When it is determined that at least one of the first to third concurrent communication limit numbers is exceeded, the execution of the facsimile communication with respect to the first or second data communication apparatus is limited. With this configuration, such a situation is avoided that while a plurality of facsimile communications can be concurrently executed, as the predetermined number of communications is exceeded, the system load becomes large and those processings are not performed in time.

In FIG. 2, a digital multifunction apparatus 202 includes a control unit 204 for governing operations of the entire digital multifunction apparatus. Then, the digital multifunction apparatus 202 includes a printer apparatus 214 configured to print an output image on a recoding sheet and a reader apparatus 218 configured to read an input image from the recoding sheet and take the image into the apparatus as data.

The control unit 204 communicates with the respective terminal apparatuses through an input and output unit 205 configured to govern the input and output with respect to individual client terminals or server terminals via a communication line 203 which is connected to the network 201. Also, an input and output buffer 206 is utilized for transmitting and receiving various data including a control code for printing which is input from the network and various PDL data within the apparatus.

It is noted that the input and output unit 205 of the image forming apparatus illustrated in FIG. 2 is configured to be able to execute the T.30 communication with the T.30 communication capable facsimile apparatus via the network 201. Also, the input and output unit 205 is configured to be able to execute the T.38 communication with the T.38 communication capable facsimile apparatus via the T.38 GW.

The CPU 207 controls the operations of the entire control unit 204. A program for describing the operations of the CPU 207 is saved in a program ROM 222.

A RAM 212 is used as a work memory for performing a calculation required for an interpretation and a print of the above-described control code and data, reading of an image, and the like, and for performing a processing on the input image data. It is noted that on the RAM, a non-volatile RAM (NVRAM) 233 is provided for storing data that is necessary to be saved even a power source of the apparatus is turned OFF.

The program ROM 222 includes a control data interpretation unit 223 configured to interpret print control data received from a host computer. The program ROM 222 also includes a PDL data interpretation unit 224 configured to interpret the PDL and an image information generation unit 225 configured to generate various image objects.

Furthermore, the program ROM 222 also includes a bitmap image expansion unit 226 configured to expand an image object to a bitmap image and an image compression/decompression unit 227 configured to perform a compression/decompression processing on the bitmap image obtained through the respective processings.

In addition, the program ROM 222 also includes an image data print unit 228 configured to govern the control at the time of the image data printing, an image data transmission unit 229 configured to govern the control at the time of the image data transmission, and an image data reading unit 230 configured to govern the control at the time of the image data scanning.

In addition, the program ROM 222 also includes a registered image management unit 231 configured to reuse the expanded image or the PDL data for the printing and store and manage overlay data utilized as a template form in a external memory unit 210.

Moreover, the program ROM 222 also includes a user management unit 232 configured to manage user information such as a user name of a user who can utilize the apparatus and a password. In addition, the program ROM 222 also includes a user authentication unit 236 configured to perform an authentication of a user in a case where the apparatus is accessed by way of the data and the panel and an image synthesis unit 237 configured to issue a color processing failure warning at the time of variable print and solve the failure.

A bitmap image transfer unit 217 is configured to transfer the bitmap image expanded by the bitmap image expansion unit, the bitmap image read by the reader apparatus, and the like to the printer apparatus. A scanner I/F unit 220 connects among an engine I/F unit 216 which connects a control unit of the printer apparatus 214, the reader apparatus 218, and the control unit.

In addition, a bitmap image reception unit 221 is configured to take in the bitmap image read from the reader apparatus 218. Then, an operation panel unit 208 is configured to input information for limiting commands for each user, perform the operations of the entire apparatus, and display an error, an operation guide, and the like.

Furthermore, a panel I/F unit 209 connects the control unit 204 and the operation panel unit 208. A memory I/F unit 211 connects among the external memory unit 210 utilized for the saving of the print data, the image data input from the outside, various information of the print apparatus, etc., the control unit, and an external memory. In addition, the memory I/F unit 211 is provided with a system bus 213 which connects the respective units.

The operation panel unit 208 includes a liquid crystal panel on which a registered registration screen is displayed and various information of the present digital multifunction apparatus such as a print situation is displayed. This liquid crystal panel also functions as a touch panel. In a case where the user touches the touch panel, the input is detected, and it is possible to input text information or the like from the screen.

Also, on the operation panel unit 208, a start key for instructing a start of the copying, a reset key for resetting the apparatus, an ON/OFF switch for the power source, numeric keypads for specifying the number of copies, and the like are arranged. In addition, on the operation panel unit 208, a cursor key and an enter key utilized for moving a cursor displayed on the liquid crystal panel and selecting the displayed functions, and keys of copied functions of the digital multifunction apparatus are arranged. Furthermore, on the operation panel unit 208, a function key for switching modes to the image transmission and the document management and a login key for identifying and authenticating the user of the apparatus.

In addition, in the printer apparatus 214, an engine control unit 215 configured to perform the print control from the sheet feed and the printing until the sheet discharge exists. Also, in the reader apparatus 218, a scanner control unit 219 configured to perform the image reading control from the feeding of the recoding sheet for reading the image and the image reading until the sheet discharge exists.

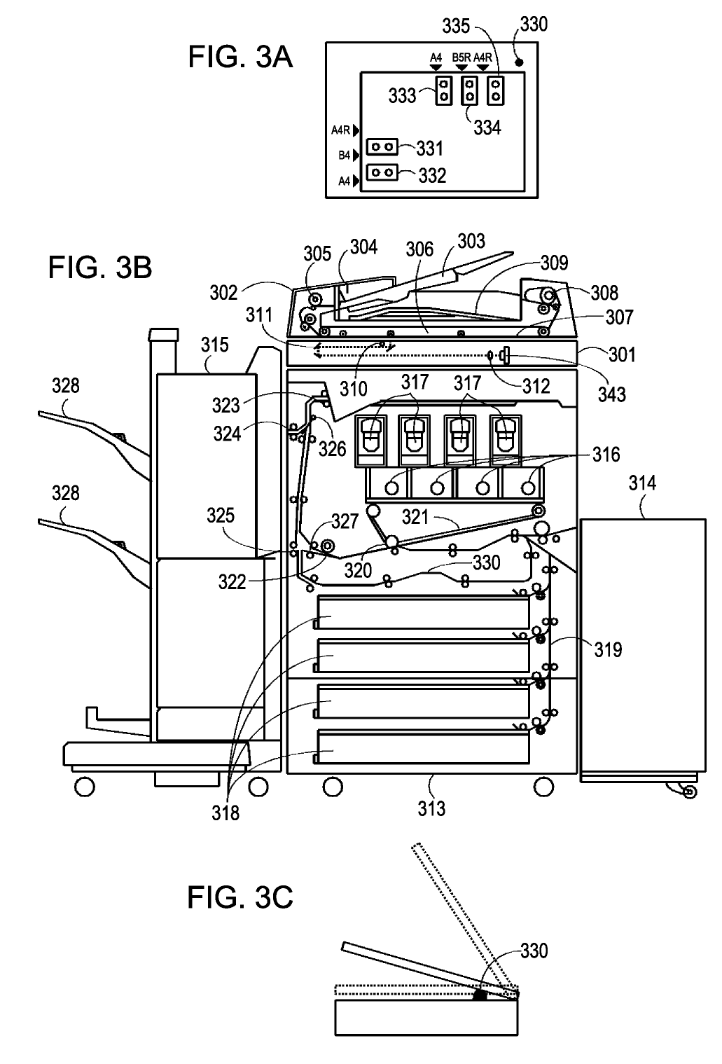

Next, a detail of the digital multifunction apparatus described in FIG. 2 will be described with reference to FIGS. 3A to 3C. This multifunction apparatus has the functions of copy, printer, FAX, and transmission.

FIGS. 3A to 3C are diagrams for describing the configuration of the image forming apparatus to which the data communication apparatus according to the present embodiment is applied. FIG. 3A illustrates a top face of an original plate of the reader apparatus 218, FIG. 3B illustrates a cross section of the image forming apparatus, and FIG. 3C illustrates a side face of an original pressing plate from which an ADF of the reader apparatus 218 is removed.

In FIGS. 3A to 3C, the multifunction apparatus is composed of a scanner 301, a document feeder (DF) 302, a printer 313 provided with four color drums for print recording, a sheet feed deck 314, and a finisher 315.

First, a description will be given of a reading operation which is performed mainly by the scanner 301.

In a case where a reading is performed by setting an original on an original plate, the original is set on an original plate 307 and the DF 302 is closed. In response to that, an open and close sensor detects that the original plate is closed, and thereafter, reflection type original size detection sensors 331 to 335 provided in a housing of the scanner 301 detect the size of the set original.

While this size detection is used as the starting point, the original is irradiated at a light source 310, and an image is read by a CCD 343 via a reflection plate 311 and a lens 312. After that, the image is converted into a digital signal. Then, a predetermined image processing is performed on the digital signal to the digital signal into a laser recording signal. The converted recording signal is stored in a memory inside a controller.

In a case where an original is set to the DF 302, the original is placed to be faced up on a tray of an original set unit 303 of the DF 302. In response to that, an original presence/absence sensor 304 detects that the original is set. As a result, an original feed roller 305 and a conveying belt 306 rotate to convey the original, and the original is set at a predetermined position on the original plate 307. After this step, the image is read similarly to the case of the reading at the original plate and stored in the memory inside the controller.

When the reading is completed in this manner, the conveying belt 306 rotates again to convey the original to the right-hand side in the drawing, and the original is discharged via a conveying roller 308 on the sheet discharge side to a sheet discharge tray 309.

In a case where a plurality of originals exists, concurrently with the original discharged and conveyed to the right-hand side in the drawing from the original plate, the next original is fed via the original feed roller 305, and a reading of the next original is continuously performed. The above-described process is the operation of the scanner.

Subsequently, a description will be given of the print operation mainly performed by the printer 313. The recording signal (the print image data) temporarily stored in the memory inside the controller is transferred to the printer 313. Then, the recording signal is converted into four color recording laser beams of Yellow, Magenta, Cyan, and Black at a laser recording unit. Then, photosensitive members 316 of the respective colors are irradiated with the laser beams, thus forming electrostatic latent images on the photosensitive members.

Then, toner development is performed by using toner supplied from toner cartridges 317, and visualized images are subjected to primal transfer onto an intermediate transfer belt 321.

After that, the intermediate transfer belt 321 is rotated in a clockwise direction, and the recording sheet fed through sheet cassettes 318 or from the sheet feed deck 314 to a sheet feed conveying path 319 reaches a secondary transfer position 320. Then, the image is transferred from the intermediate transfer belt 321 to the recording sheet.

The recording sheet onto which the image has been transferred is subjected to toner fixation at a fixing device 322 with pressure and heat. After conveyed through a sheet discharge conveying path, the recording sheet is discharged to the outside of the apparatus. At this time, the recording sheet is discharged faced down to a center tray 323, switched backed to a sheet discharge port 324 of the finisher, or discharged faced up to a side tray 325.

It is noted that the side tray 325 can be used as a sheet discharge port only in a case where the finisher 315 is not mounted.

Flappers 326 and 327 are used for switching the sheet feed paths to switch these sheet discharge ports. In a case of a duplex print, after the recording sheet passes through the fixing device 322, the flapper 327 switches the sheet feed path. After that, the recording sheet is switched back and the recording sheet is fed downward. The recording sheet passes through a duplex printing sheet conveying path 330 to be fed to the secondary transfer position 320 again, thus realizing the duplex operation.

Subsequently, an operation performed in the finisher 315 will be described. In the finisher 315, in accordance with a function specified by the user, a post-processing is performed on the printed sheet.

To be more specific, the functions of stapling (one spot or two spot binding), punching (two holes or three holes), saddle stitching, and the like are provided.

The multifunction apparatus illustrated in FIGS. 3A to 3C has two sheet discharge trays 328. For the recording sheet passing through the sheet discharge port 324 towards the finisher 315, based on a setting by the user, for example, it is possible to sort out the sheet discharge trays for each of the functions of copying, printer, FAX, and transmission.

Although the printer 313 is the color four drum printer in this example, the printer may be composed of a color one drum engine or a monochrome printer engine of course.

In a case where this apparatus is used as the printer, depending a driver, it is possible to make various settings such as monochrome print/color print, sheet size, 2UP/4UP print or N-UP print, duplex, stapling, punching, saddle stitching, inserted sheet, front cover, and back cover.

Next, a function and an operation of the controller of the digital multifunction apparatus in the above-described system configuration will be described by using the host computer as an example.

Herein, the operation with the host computer will be described as an example, but other host computer or an arbitrary host computer on the network has the similar effects.

### <User Authentication>

The image forming apparatus according to the present embodiment, when a user ID and a password are detected during the interpretation of the control data, a checking as to whether the relevant user may utilize the digital multifunction apparatus is performed in the user management unit 232.

In response to the specification from the user, when the print execution of the document created in the host computer is instructed, a control code and print data (data described in the PDL or the like) transmitted from the host computer via the communication line 203 are supplied. Then, the data is accumulated in the RAM 212 via the input and output buffer 206 through the host I/F unit 205. Herein, for example, packet data is transmitted as the data.

Then, a header of the packet data stores an ID representing a packet type. At this time, as the print data is used, an ID representing the print data is stored.

Next, apparatus control data is provided. The apparatus control data is composed of a sequence of commands for setting a control instruction for the apparatus, a change for a default setting of the apparatus, a management state of the apparatus, and the like.

In addition, among the apparatus control data, in a host computer 1, a user ID previously issued for utilizing the apparatus and a password corresponding to the ID are embedded as a part of the data.

Furthermore, data of the PDL is included and transmitted as the print data, which follows the apparatus control data or is sandwiched between pieces of the apparatus control data.

The input data is subjected to the following authentication processing by the user management unit 232 when the user ID is recognized during the interpretation of the apparatus control data. In other words, the user ID and the password are checked by referring to a user information management table 234 in the currently registered user information on the NVRAM 233. At this time, when the authentication is obtained, the control data is subjected to the processing in a mode of the user who obtains the authentication (hereinafter referred to as authenticated user) until the end of the processing.

On the other hand, at this time, in a case where the authentication is not obtained because the user ID does not exists, the password is not correct, etc., an operation is performed in a range that is allowed for the user who does not obtain the authentication (hereinafter referred to as non-authenticated user).

In usual cases, the processing is often in a standby state until the user information is determined. In a case where the processing is varied depending on a user as illustrated in the present embodiment, if the user authentication processing is performed as soon as possible, other processing is not delayed.

According to the present embodiment, it is assumed that the data of the user ID and the password is set prior to other limiting commands.

In addition, the user authentication is performed the operation panel unit 208 as well. When the login key is pressed, a screen for inputting the user name and the password appears on the liquid crystal panel. At this time, through the cursors operated by the user, the user ID and the password are input, thus performing the user authentication. Thus, it is possible to perform a processing in accordance with each authenticated user. In a case where the operation is started without pressing the login key, only an operation in a range that is allowed for the non-authenticated user can be performed.

### <Image Generation Function>

The image forming apparatus according to the present embodiment is provided with an image generation function for printing or registering the document specified with the host computer. The CPU 207 follows the program described in the program ROM 222. For the print data, first, a part of the control data is cut out. Then, with the cut control data, an instruction of a function executed by various control instructions of the apparatus, a setting of default information of the apparatus, and the like are performed by the control data interpretation unit 223.

Herein, the user authentication is performed by the above-described user authentication unit. After the user authentication is performed and the processing in the control data interpretation unit 223 is ended, the interpretation of the PDL data is performed in the PDL data interpretation unit 224. Then, based on an interpretation result of the PDL data, the data is processed in the image information generation unit 225 to generate image information related to a figure, a character, image data, or the like, piece by piece (image object).

Then, after image information is generated for all the image objects in one page to be printed, the image objects in the page are expanded into bitmap images which can be actually printed in the bitmap image expansion unit 226 and stored in the RAM 212.

After that, the bitmap images are compressed in the image compression/decompression unit 227 to be stored as compressed images.

Also, through the specification of the control code, it is possible to store the following data on the RAM 212 for the purpose of being operated with an image registration function described below in a collaborative manner. Herein, the data includes data which is not processed by the control data interpretation unit 223 or the PDL data interpretation unit 224 and image (intermediate object image) data which is not expanded by the bitmap image expansion unit 226.

### <Scan Image Reading Function>

The digital multifunction apparatus according to the present embodiment is provided with a scan image reading function for printing or registering the image read from the original through the reader unit.

In response to the specification from the user, a scanning is instructed through a control command from the operation panel unit 208 or the host computer.

To be more specific, the instruction from the user is input through the panel I/F unit 209 from the operation panel unit 208. As a result, the CPU 207 reads out the program of the image data reading unit 230 described in the program ROM 222. Then, the CPU 207 controls the operation of the reader apparatus 218 through the scanner I/F unit 220 to take in the scan image of the original document from the reader apparatus 218 through the scanner I/F unit 220.

After that, the taken image data is stored in the RAM 212 through the bitmap image reception unit 221 and the bitmap images are compressed by the image compression/decompression unit 227, so that the images are held in the RAM 212 as the compressed images.

### <Image Registration Function>

The image forming apparatus according to the present embodiment is provided with an image registration function for registering and saving the image obtained based on the image generation function or the scan image reading function in the external memory unit 210.

A description will be provided of a case in which the registration of the above-described image obtained based on the image generation function or the scan image reading function is specified.

In this case, the compressed images held in the RAM 212 are saved in the external memory unit 210 directly as a file name of File0001 through the memory I/F unit 211 and registered by the registered image management unit 231 together with various setting information on the RAM 212.

This print setting is appropriately written in the NVRAM 233, which is non-volatile, and thus even when the power source is turned OFF, the information is saved.

In addition, according to this image registration function, the method of registering the compressed images obtained by compressing the above-described bitmap images is used, but other method may also be employed. For example, data which is not interpreted by the control data interpretation unit 223 or the PDL data interpretation unit 224 or intermediate object images which are not expanded by the bitmap image expansion unit 226 can also be directly registered.

### <Image Print Function>

The image forming apparatus according to the present embodiment is, as described above, provided with the image generation function or an image print function of printing the compressed images held on the RAM 212 by the scan image reading function.

Also, when the print of the image obtained based on the image generation function or the scan image reading function is specified, the CPU 207 executes the program of the image data print unit 228 described in the program ROM 222. Then, the CPU 207 expands the compressed images held in the RAM 212 with the image compression/decompression unit 227 into the bitmap images for performing the print processing.

In this case, various print settings such as the sheet feed port, the sheet discharge port, and the print mode are set in the engine control unit 215 through the engine I/F unit 216. In response to that, the selected image is sent to the engine unit in the bitmap image transfer unit 217 through the engine I/F unit 216, and the sheet is discharged from the specified sheet discharge port after the print is performed.

Also, based on the image registration function, it is possible to print the registered image. In that case, in accordance with the image stored on the RAM 212, the following processing is performed in the case of data including the control data.

In this case, the control data interpretation unit 223 performs the data interpretation. In the case of the PDL data, the PDL data interpretation unit 224 performs the data interpretation. Then the data is processed in the image information generation unit 225 to generate the intermediate object images.

Then, in the bitmap image expansion unit 226, the image objects in the page are expanded into the bitmap images which can be actually printed. After that, the expanded bitmap image data is transmitted to the engine unit in the bitmap image transfer unit 217 through the engine I/F unit 216 to perform the print.

Also, in the case of the intermediate object images, the image objects in the page are expanded in the bitmap image expansion unit 226 into the bitmap images which can be actually printed in a page unit. Then, the expanded bitmap image data is transmitted to the engine unit in the bitmap image transfer unit 217 through the engine I/F unit 216 to perform the print.

### <Print Function>

In the image forming apparatus according to the present embodiment, a print function is realized through a print function of continuously using the image generation function and the image print function. The print instruction from the host computer by the user is realized by this print function.

When the print instruction is performed in this way, the CPU 207 executes the image generation function and the image print function, and the image of the document transmitted from the host computer is expanded and accumulated through the image generation function. Then, along with this, the print is executed based on the image print function, and the document generated in the host computer is printed in the printer apparatus.

### <Copy Function>

In the image forming apparatus according to the present embodiment, a copy function is realized through a print function of continuously using the scan image reading function and the image print function.

The copy instruction is performed by the user while setting the original desired to be copied on the reader apparatus, selecting a copy key on the panel, and pressing a start key, or performed in response to a command of the control data from the host computer. In response to that, the CPU 207 executes the scan image reading function and the image print function, and the scan image of the original is accumulated in the RAM 212 based on the scan image reading function. Along with this, the print based on the image print function is executed to print the image read by the printer apparatus.

### <Image Transmission Function>

The image forming apparatus according to the present embodiment has a function of transmitting the image data registered based on the image registration function. The user instructs the transmission by selecting the original desired to be transmitted with a transmission key while selecting the document displayed on the liquid crystal panel or selecting with the host computer. In response to that, the CPU 207 follows the program of the image data transmission unit 229 described in the program ROM 222 to convert the images into the bitmap images with the image compression/decompression unit 227 to be saved in the RAM 212.

After that, among the images saved in the RAM 212, the user attaches the image to a mail address specified by the panel or the host computer and transmits the image via the input and output buffer from the input and output unit.

It is noted that according to the present embodiment, in general, the facsimile apparatus is connected to the analog public line (telephone circuit). The facsimile apparatus uses the procedure while following ITU-T Recommendation T.30 and uses a modem for processing the analog signal, thus achieving the T.30 communication to transmit and receive the image data.

On the other hand, the facsimile communication via the network circuit uses the procedure while following ITU-T Recommendation T.38, thus achieving the digital facsimile communication to transmit and receive the digital data.

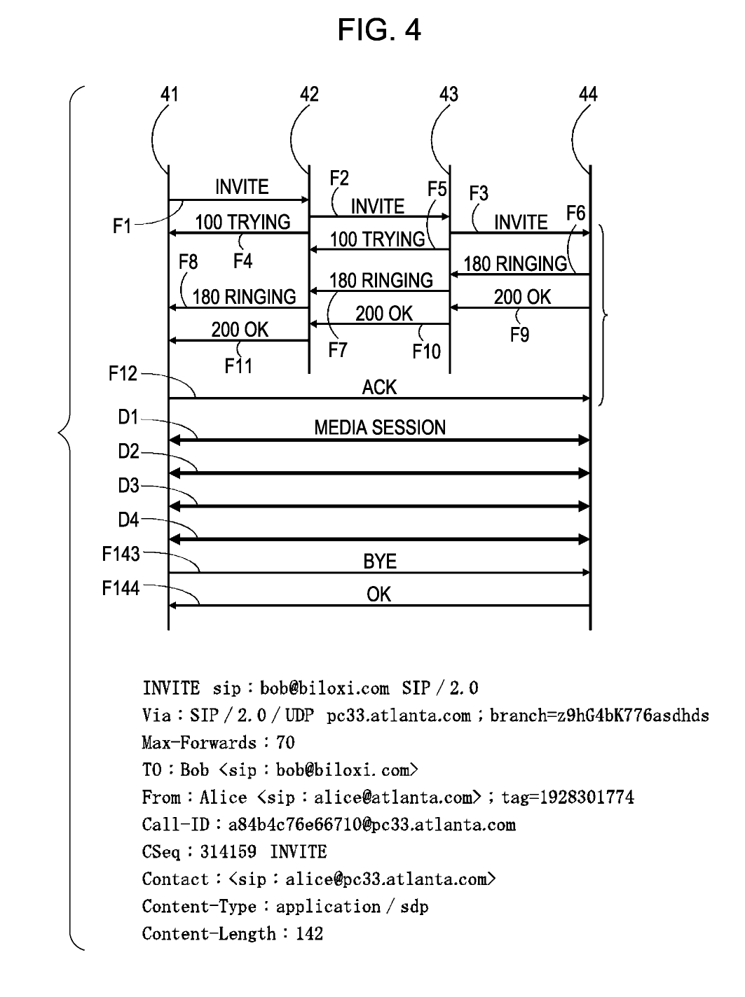

FIG. 4 illustrates a first session example in the data communication apparatus according to the present embodiment. The present example illustrates a communication outline between the T.38 communication capable facsimile apparatuses alone via the network. It is noted that for convenience, the description is provided while using a relation between the transmission apparatus and the reception apparatus, but each of the apparatuses may also be constituted by a data processing apparatus provided with an IP (Internet Protocol) communication function, that is, a computer apparatus. Furthermore, as will be described later, the similar effects are obtained in the case of an image forming apparatus provided with the IP communication function. It is noted that in FIG. 4, F1 to F14 represent each session and D1 to D4 represent data transfer.

First, from a transmission apparatus 41 to a SIP (Session Initiation Protocol) server 42, INVITE is issued as a session initiation request and an outgoing call is started (F1). The SIP server 42 having received this request on the transmission side issues INVITE to a SIP server 43 on the reception side (F2). Along with this, a reply to the transmission apparatus 41 is required within a predetermined time, and TRYING as an interim reply is returned to the transmission apparatus 41 (F4).

Then, the SIP server 43 on the reception side having received INVITE from the SIP server 42 on the transmission side issues INVITE to a reception apparatus 44 (F3). Along with this, and TRYING as an interim reply is returned to the SIP server 42 on the transmission side (F5).

After that, the reception apparatus 44 having received INVITE from the SIP server 43 on the reception side plays a ringing tone and return RINGING to the SIP server 43 on the reception side when a reply can be made (F6). The SIP server 43 on the reception side having received this reply returns RINGING to the SIP server 42 on the transmission side (F7).

The SIP server 42 having received this reply on the transmission side returns RINGING to the transmission apparatus 41 (F8). In parallel to this reply of RINGING, when a reply can be made at the transmission apparatus 41, as the request is success, OK is returned to the SIP server 43 on the reception side (F9).

The SIP server 43 having received this reply on the reception side returns OK to the SIP server 42 on the transmission side (F10). The SIP server 42 having received this reply on the transmission side returns OK to the transmission apparatus 41 (F11).

The transmission apparatus 41 having received this reply replies ACK informing that the session initiation has been confirmed to the reception apparatus (F12). Thus, the call connection between the apparatuses has been established. The above-described control is a call control example based on the SIP in the T.38 communication.

Next, the data transfers D1 to D4 are performed as Media Session between the transmission apparatus 41 and the reception apparatus 44 where the call connection has been established.

Then, when all the data transfers are ended, from the transmission apparatus 41 to the reception apparatus 44, BYE is issued as a session end request (F13). The reception apparatus 44 having received this request replies OK to the transmission apparatus 41 (F14), and the call is disconnected to end the T.38 communication.

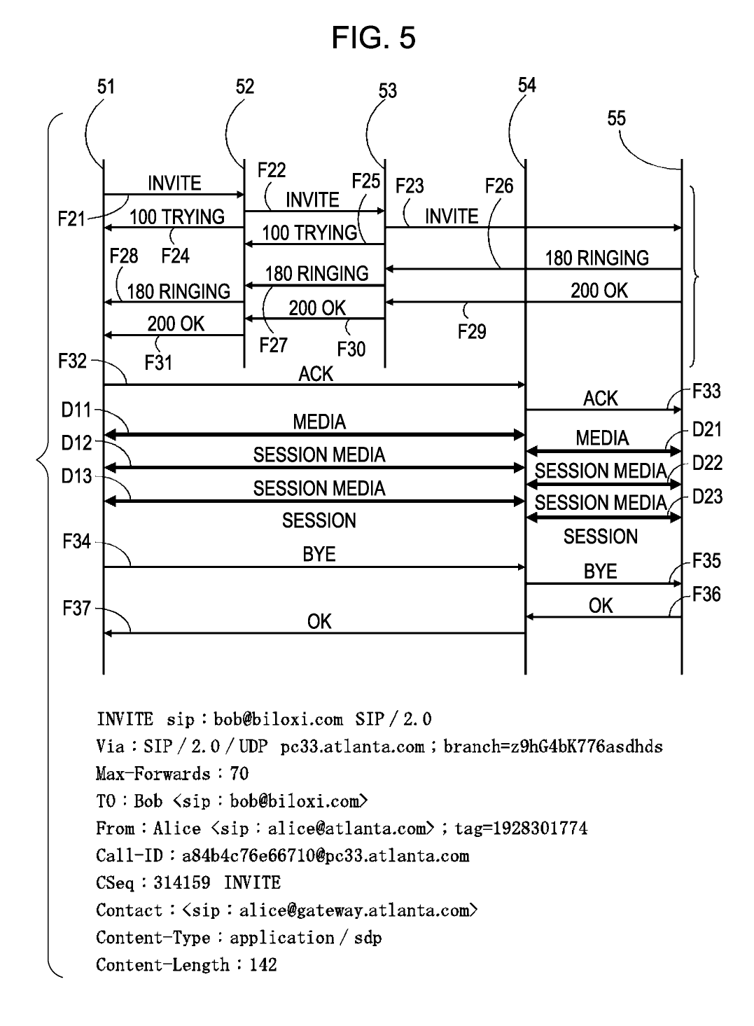

FIG. 5 illustrates a second session example in the data communication apparatus according to the present embodiment. The present example illustrates a communication outline between a T.38 communication capable facsimile apparatus and a facsimile apparatus connected via the T.38 GW. It is noted that in FIG. 4, F21 to F36 represent each session and, D11 to D13 and D21 to D23 represent data transfers.

First, from the transmission apparatus 51 to a SIP server 52, INVITE is issued as a session initiation request and an outgoing call is started (F21), and the SIP server 52 having received this request on the transmission side issues INVITE to a SIP server 53 on the reception side (F22). Along with this, a reply to the transmission apparatus 51 is required within a predetermined time, and TRYING as an interim reply is returned to the transmission apparatus 51 (F24).

Then, the SIP server 53 having received INVITE on the reception side from the SIP server 52 on the transmission side makes an outgoing call via a T.38 GW 54 to a reception apparatus 55 while following the T.30 communication procedure (F23). Along with this, TRYING as an interim reply is returned to the SIP server on the transmission side (F25).

Then, the reception apparatus 55 having the outgoing call based on INVITE from the SIP server 53 on the reception side returns RINGING to the SIP server 53 on the reception side via the T.38 GW 54 when a reply can be made (F26).

The SIP server 53 having received this reply on the reception side via the T.38 GW 54 returns RINGING to the SIP server 52 on the transmission side (F27).

The SIP server 52 having received this reply on the transmission side returns RINGING to the transmission apparatus 51 (F28). In parallel to this reply of RINGING, when a reply can be made at the reception apparatus 55, as the request is success, OK is returned to the SIP server 53 on the reception side via the T.38 GW 54 (F29).

The SIP server 53 having received this reply via the T.38 GW 54 on the reception side returns OK to the SIP server 52 on the transmission side (F30). The SIP server 52 having received this reply on the transmission side returns OK to the transmission apparatus 51 (F31). The transmission apparatus 51 having received this reply replies ACK informing that the session initiation has been confirmed to the T.38 GW 54 (F32). The T.38 GW 54 having received this request replies ACK to the reception apparatus 55 (F33). Thus, the call connection between the apparatuses has been established.

Next, the data transfers D11 to D13 are performed as Media Session between the transmission apparatus 51 and the T.38 GW where the call connection has been established.

Furthermore, the data transfers D21 to D23 based on the T.30 communication are performed as Media Session between the T.38 GW 54 and the reception apparatus 55 where the call connection has been established.

When all the data transfers are ended, from the transmission apparatus 51 to the T.38 GW 54, BYE is issued as a session end request (F34). Then, BYE is issued from the T.38 GW 54 to the reception apparatus 55 (F35). The reception apparatus 55 having received this request replies OK to the T.38 GW 54 (F36), and then the T.38 GW 54 replies OK to the transmission apparatus 51 (F37). Thus, the call is disconnected to end the T.38 communication and the T.30 communication.

FIG. 6 is a flowchart illustrating a first communication processing procedure in the data communication apparatus according to the present embodiment. This processing is a communication control example at the time of a new communication request according to the present invention in the system environment illustrated in FIG. 5. It is noted that S601 to S611 represent each step. Also, each step is realized while the CPU 207 illustrated in FIG. 2 loads a communication control program stored in the program ROM 222 onto the RAM 212 for the execution.

First, in S601, a new session initiation request is transmitted to the T.38 communication capable facsimile apparatus.

In this situation, in S602, the CPU 207 of a T.38 communication capable facsimile apparatus determines about a communication partner. To be more specific, the CPU 207 determines whether the communication partner of this session initiation request is the T.38 communication capable facsimile apparatus or the T.30 communication capable facsimile apparatus connected via the T.38 GW. This is because, in order to limit concurrent communications based on a concurrent communication limit number as will be described in FIG. 7 later, it is necessary for the CPU 207 to determine whether the session initiation request is transmitted from which communication partner.

At this time, in a case where it is determined that the new session initiation request is transmitted from the T.38 communication capable facsimile apparatus, it is determined in S603 whether the concurrent communication limit number of the T.38 communications is already reached when this communication request is transmitted.

It is noted that the concurrent communication limit number of the T.38 communications is configured so as to be previously set by a command from the operation panel unit 208 or the host computer (not illustrated). The limiting command management table 235, which is stored in the NVRAM 233, manages the concurrent communication limit number of the T.38 communications. In addition, a setting processing of the concurrent communication limit number from the operation panel unit 208 will be described in detail with reference to FIG. 7. At this time, a reason why the concurrent communication limit number is set is that when a communication is performed with the T.30 communication capable facsimile apparatus via the T.38 GW or via the public line, a problem that performing this processing becomes too late is avoided. It is noted that the concurrent communication limit number is held on the RAM 212 after an initialization processing is performed, and is referred to by the CPU 207 at the time of communication control.

In S603, in a case where the CPU 207 determines that the concurrent communication limit number of the T.38 communications is reached, in S606, a processing of refusing the new session initiation request from the T.38 communication capable facsimile apparatus is executed to end this process.

On the other hand, in S603, in a case where the CPU 207 determines that the concurrent communication limit number of the T.38 communications is not reached, it is determined in S604 whether a concurrent communication limit number the concurrent communication limit number of the entirety of the T.38 communications and the T.30 communications is reached. At this time, in a case where the CPU 207 determines that the concurrent communication limit number of the entirety of the T.38 communications and the T.30 communications is reached, the process advances to S606 in which a processing of rejecting the new session initiation request from the T.38 communication capable facsimile apparatus is executed.

On the other hand, in S604, in a case where the CPU 207 determines that the concurrent communication limit number of the entirety of the T.38 communications and the T.30 communications is not reached, in S605, this new session initiation request from the T.38 communication capable facsimile apparatus is accepted as a new incoming call. Then, in S611, all the concurrent communications are continued and this process is ended.

On the other hand, in S602, when it is determined that the new session initiation request is transmitted from the T.30 communication capable facsimile apparatus connected via the T.38 GW, it is determined in S607 whether a concurrent communication limit number of the T.30 communications already executed via the T.38 GW 54 is reached when this communication request is transmitted.

At this time, in a case where the CPU 207 determines that the concurrent communication limit number of the T.30 communications is reached, the process advances to S610. Then, in S610, a processing of rejecting the new session initiation request from the T.30 communication capable facsimile apparatus is rejected.

On the other hand, in a case where the CPU 207 determines in S607 that, that the concurrent communication limit number of the T.30 communications is not reached, the process advances to S608. Then, the CPU 207 further determines in S608 whether the concurrent communication limit number of the entirety of the T.38 communications and the T.30 communications is reached. At this time, in a case where the CPU 207 determines that the concurrent communication limit number of the entirety of the T.38 communications and the T.30 communications is reached, the process advances to S610. Then, in S610, a processing of rejecting the new session initiation request from the T.30 communication capable facsimile apparatus is executed and this process is ended.

On the other hand, the CPU 207 determines in S608 that the concurrent communication limit number of the entirety of the T.38 communications and the T.30 communications is not reached, the process advances to S609. Then, in S609, this new session initiation request from the T.30 communication capable facsimile apparatus is accepted as a new incoming call, and in S611, all the concurrent communications are continued and this process is ended.

It is noted that according to the present embodiment, the first or second concurrent communication number found in S603 or S607 is determined with priority compared with the third concurrent communication number found in S604 or S608. When the first or second concurrent communication number is exceeded, the communication request is limited immediately.

With this configuration, in a case where the concurrent communication number set by the user is not exceeded, it is possible to avoid the problem that performing the processing becomes too late when the communication is established with the T.30 communication capable facsimile apparatus via the T.38 GW or the public line.

FIG. 7 is a diagram for describing a display transit of a user I/F screen of a user mode displayed on the operation panel unit 208 illustrated in FIG. 2. The present example is a display shift example in which the user I/F screen is changed as the user issues operation instructions from the operation panel unit 208. Herein, the display shift is a screen shift example for setting the concurrent communication limit number of the T.38 communications.

To be more specific, this is an operation screen example of the setting related to the concurrent communication limit number illustrated in FIG. 6. This concurrent communication limit number is information for the CPU 207 to determine whether the new session initiation request is accepted.

It is noted that S701 to S704 correspond to a situation related to the instructions to the operation panel unit 208 and the shift state of the operation screen.

First, in S701, a “User mode” key (not illustrated) displayed on the operation panel unit 208 is pressed, the screen is switched to a user mode main screen illustrated in S702 in accordance with the control of the CPU 207.

Herein, on the user mode main screen, buttons B1 to B10 are displayed. In this example, the button B1 is a button used for performing a “Common specification setting”. The button B2 is a button used for performing a “Timer setting”. The button B3 is a button used for performing an “Adjustment/cleaning”. The button B4 is a button used for performing a “Report specification setting”.

The button B5 is a button used for performing a “System management setting”. The button B6 is a button used for performing a “Copy specification setting”. The button B7 is a button used for performing a “Transmission/reception specification setting”. The button B8 is a button used for performing a “Box specification setting”. The button B9 is a button used for performing a “Printer specification setting”. The button B10 is a button used for performing an “Address table specification setting”.

From the screen, when the button B7 corresponding to “Transmission/reception specification setting” is pressed by the user, the screen is switched to a transmission/reception specification setting screen illustrated in S703.

On this transmission/reception specification setting screen, buttons B11 to B13 are displayed.

The button B11 is a button used for performing a “transmission use setting”. The button B12 is a button used for performing a “reception use setting”. The button B13 is a button used for performing a “T.38 concurrent communication number setting”. From this transmission/reception specification setting screen, when the user presses the “T.38 concurrent communication number setting” button corresponding to the button B13, the screen is switched to a T.38 concurrent communication number setting screen display illustrated in S704.

On this T.38 concurrent communication number setting screen, it is possible for the user to set the concurrent communication limit number at the time of executing the T.38 communications.

That is, three types of the concurrent communication limit number can be set, for example, which include “Concurrent communication limit number of T.38 communication capable facsimile apparatuses alone”, “Concurrent communication limit number of T.30 communication capable facsimile apparatuses via T.38 GW”, and “Concurrent communication limit number of entirety of T.38 communications and T.30 communications”.

According to the present embodiment, the following examples are adopted regarding settable ranges for the respective limit values. The “Concurrent communication limit number of T.38 communication capable facsimile apparatuses alone” is prescribed as “1 to 10”. This allows setting of the limit value for the number of apparatuses such as the transmission apparatus 41 and the reception apparatus 44 illustrated in FIG. 4 which can mutually perform the T.38 communication.

Then, the “Concurrent communication limit number of T.30 communication capable facsimile apparatuses via T.38 GW” is prescribed as “1 to 3”. Furthermore, the “Concurrent communication limit number of entirety of T.38 communications and T.30 communications” is prescribed as “2 to 13”.

Herein, the user can freely set the three types of the limit numbers within the respective settable ranges by using the numeric keypads (not illustrated) in the operation panel unit 208.

In addition, according to the present embodiment, the value of the “Concurrent communication limit number of entirety of T.38 communications and T.30 communications” is set as follows. For example, a summation (in this case, 13, for example) of the value of the “Concurrent communication limit number of T.38 communication capable facsimile apparatuses alone” (in this case, 10, for example) and the value of the “Concurrent communication limit number of T.30 communication capable facsimile apparatuses via T.38 GW” (in this case, 3, for example) is set. It is noted that the values can be set freely if this summation is not exceeded. Herein, the summation means the concurrent communication limit number of the entirety of the T.38 communications and the T.30 communications.

In other words, the concurrent communication limit number of the T.38 communication capable facsimile apparatuses alone and the concurrent communication limit number of the T.30 communication capable facsimile apparatuses via the T.38 GW are individually provided, and at the same time, the concurrent communication limit number of the entirety of the T.38 communications and the T.30 communications is independently provided.

With this configuration, it is possible for the user to perform the detailed setting/operation in accordance with a traffic situation of the network circuit or the public analog circuit.

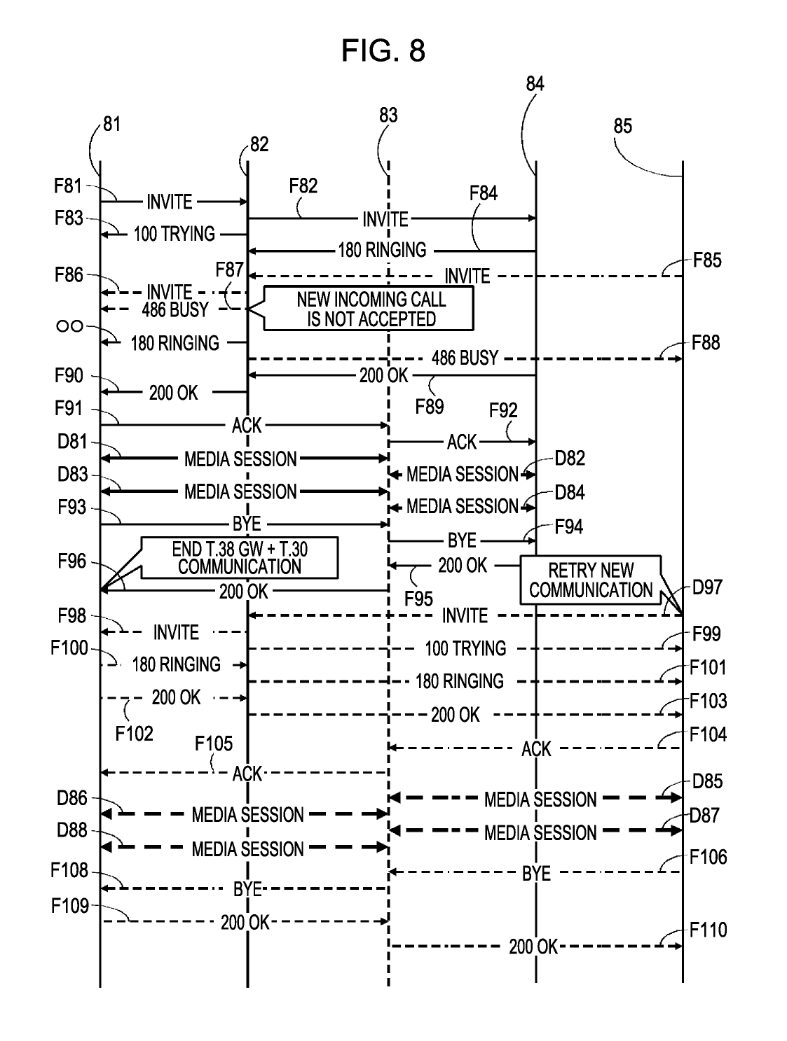

FIG. 8 is a diagram for describing a first communication phase example in the image forming apparatus to which the data communication apparatus according to the present embodiment is applied. The present example is premised on that the T.38 communication capable facsimile apparatus has the above-described user mode illustrated in FIG. 7 with which the concurrent communication limit number can be set and the above-described determination on the new session initiation request illustrated in FIG. 6 has the routine.

This corresponds to a communication example in a case where the concurrent communication limit number of the T.30 communication capable facsimile apparatuses 84 and 85 connected via a T.38 GW 83 is reached, new session initiation requests are transmitted from the facsimile apparatuses 84 and 85.

It is noted that according to the present embodiment, the above-described concurrent communication limit numbers illustrated in FIG. 7 are previously set by the user in the operation panel unit 208.

Herein, the “Concurrent communication limit number of T.38 communication capable facsimile apparatuses alone” is set as “10”, the “Concurrent communication limit number of T.30 communication capable facsimile apparatuses via T.38 GW” is set as “3”, and the “Concurrent communication limit number of entirety of T.38 communications and T.30 communications” is set as “13”. A description will be provided of a case where while the concurrent communication number of the T.30 communication capable facsimile apparatuses via the T.38 GW has already reached “3” that is the limit value, the new session initiation requests are transmitted from the facsimile apparatuses 84 and 85.

In addition, for simplicity, in the communication example illustrated in FIG. 8, a description will be provided of a case where SIP servers of the facsimile apparatuses 84 and 85 are omitted and only a single T.38 GW 83 is provided as the T.38 GW is provided.

Hereinafter, a facsimile apparatus 81 is a T.38 communication capable facsimile apparatus. Also, F81 to F110 represent each session.

First, from the facsimile apparatus 81 to a SIP server 82, INVITE is issued as a session initiation request and an outgoing call is started (F81). The SIP server 82 of the facsimile apparatus 81 having received this request issues INVITE to a SIP server (not illustrated) of the facsimile apparatus 84 (F82).

Along with this, the SIP server 82 is required to reply within a predetermined time to the facsimile apparatus 81, and thus TRYING as an interim reply is returned to the facsimile apparatus 81 (F83). The SIP server (not illustrated) of the facsimile apparatus 84 having received INVITE from the SIP server 82 of the facsimile apparatus 81 issues INVITE via the T.38 GW 83 to the T.30 communication capable facsimile apparatus 84 while following the T.30 communication. Along with this, TRYING as an interim reply is returned to the SIP server 82 of the facsimile apparatus 81.

In this manner, the facsimile apparatus 84 having received INVITE from the SIP server (not illustrated) of the facsimile apparatus 84 via the T.38 GW 83 performs the following processing when a reply can be made. For example, a ringing tone is played to the SIP server (not illustrated) of the facsimile apparatus 84 and RINGING is returned via the T.38 GW 83 (F84).

The SIP server (not illustrated) of the facsimile apparatus 84 having received this reply via the T.38 GW 83 returns RINGING to the SIP server 82 of the facsimile apparatus 81.

At this stage, from the facsimile apparatus 85 via the T.38 GW 83 to a SIP server (not illustrated) of the facsimile apparatus 85, INVITE is issued as a new session initiation request and an outgoing call is started while following the T.30 protocol.

With this configuration, the SIP server (not illustrated) of the facsimile apparatus 85 having received INVITE via the T.38 GW 83 from the facsimile apparatus 85 issues INVITE to the SIP server 82 of the facsimile apparatus while following the T.38 protocol (F85).

Then, the SIP server 82 of the facsimile apparatus 81 having received INVITE from the SIP server (not illustrated) of the facsimile apparatus 85 issues INVITE to the T.38 communication capable facsimile apparatus (F86).

Then, the facsimile apparatus 81 having received INVITE from the SIP server 82 of the facsimile apparatus 81 is in a state where the concurrent communication number with the G3 FAX via the T.38 GW 83 has already reached “3” that is the limit number. For this reason, based on the above-described determination in the flowchart of FIG. 6, the session initiation request from the facsimile apparatus 85 is not accepted. Thus, Busy is returned to the SIP server 82 of the facsimile apparatus 81 (F87), and the new incoming call of the G3 FAX via the T.38 GW 83 is rejected.

In this manner, the SIP server 82 of the facsimile apparatus 81 having received Busy from the facsimile apparatus 81 issues Busy to the SIP server (not illustrated) of the facsimile apparatus 85. The SIP server (not illustrated) of the facsimile apparatus 85 having received Busy from the SIP server 82 of the facsimile apparatus 81 issues Busy to the facsimile apparatus 85 via the T.38 GW 83 while following the T.30 protocol (F88).

With this configuration, the new session initiation request from the T.30 communication capable facsimile apparatus via the T.38 GW 83 is not accepted, and therefore only the communications having already initiated are continued.

That is, the SIP server 82 of the facsimile apparatus 81 having received the reply of RINGING from the SIP server (not illustrated) of the facsimile apparatus 84 returns RINGING to the facsimile apparatus 81.

In parallel to this reply of RINGING, when a reply can be made on the facsimile apparatus 84 side, as the request is success, the facsimile apparatus 84 returns OK via the T.38 GW 83 to the SIP server (not illustrated) of the facsimile apparatus 84. The SIP server (not illustrated) of the facsimile apparatus 84 having received this reply via the T.38 GW 83 returns OK to the SIP server 82 of the facsimile apparatus 81 (F89).

The SIP server 82 of the facsimile apparatus 81 having received this reply returns OK to the facsimile apparatus 81 (F90).

The facsimile apparatus 81 having received this reply replies ACK informing that the session initiation has been confirmed to the SIP server (not illustrated) of the facsimile apparatus 84. The SIP server (not illustrated) of the facsimile apparatus 84 having received this request replies ACK to the T.38 GW 83 (F91). The T.38 GW 83 having received this request replies ACK to the facsimile apparatus 84 (F92). Thus, the call connection between the apparatuses has been established.

The above-described control is a call control based on the SIP with respect to the T.30 communication capable facsimile apparatus connected via the T.38 GW 83.

Next, the data transfer is performed as Media Session while following the T.38 protocol between the facsimile apparatus 81 and the T.38 GW 83 where the call connection is established. Furthermore, the data transfers (D81 to D84) are performed as Media Session while following the T.30 protocol between the T.38 GW 83 and the facsimile apparatus 84 where the call connection is established.

In this manner, when all the data transfers are ended, from the facsimile apparatus 81 to the T.38 GW 83, BYE is issued as a session end request (F93). Then, BYE is issued from the T.38 GW 83 to the facsimile apparatus 84 (F94).

The facsimile apparatus 84 having received this request replies OK to the T.38 GW 83 (F95), and the T.38 GW 83 replies OK to the facsimile apparatus 81 (F96). Thus, the call is disconnected. With this configuration, the T.38 communication and the T.30 communication are ended.

With this configuration, the concurrent communication number of the T.30 communication capable facsimile apparatuses via the T.38 GW 83 is changed from “3” that is the limit value to “2”. Thus, the new communication form the facsimile apparatus 85 can be concurrently accepted.

In this situation, from the facsimile apparatus 85 via the T.38 GW 83 to the SIP server (not illustrated) of the facsimile apparatus 85, INVITE is issued again as a new session initiation request and an outgoing call is started while following the T.30 protocol.

Then, the SIP server (not illustrated) of the facsimile apparatus 85 having received INVITE from the facsimile apparatus 85 via the T.38 GW 83 issues INVITE to the SIP server 82 of the facsimile apparatus 81 while following the T.38 protocol (F97). Along with this, a reply is required within a predetermined time to the facsimile apparatus 85, and thus TRYING as an interim reply is returned to the facsimile apparatus 85 via the T.38 GW 83.

In this manner, the SIP server 82 of the facsimile apparatus 81 having received INVITE from the SIP server (not illustrated) of the facsimile apparatus 85 issues INVITE to the facsimile apparatus 81 (F98). Along with this, TRYING as an interim reply is returned to the SIP server of the facsimile apparatus 85 (F99). Then, the facsimile apparatus 81 having received INVITE from the SIP server 82 of the facsimile apparatus 81 performs the above-described determination illustrated in FIG. 6. Then, from this determination result, when a reply can be made, a ringing tone is played and RINGING is returned to the SIP server 82 of the facsimile apparatus 81 (F100).

The SIP server 82 of the facsimile apparatus 81 having received this reply returns RINGING to the SIP server (not illustrated) of the facsimile apparatus 85. The SIP server (not illustrated) of the facsimile apparatus 85 having received this reply returns RINGING via the T.38 GW 83 to the facsimile apparatus 85 (F101).

In parallel to this reply of RINGING, when a reply can be made at the facsimile apparatus 81, as the request is success, OK is returned to the SIP server 82 of the facsimile apparatus 81 (F102).

The SIP server of the facsimile apparatus 81 having received this reply returns OK to the SIP server (not illustrated) of the facsimile apparatus 85. The SIP server (not illustrated) of the facsimile apparatus 85 having received this reply returns OK via the T.38 GW 83 to the facsimile apparatus 85 (F103). The facsimile apparatus 85 having received this reply replies ACK informing that the session initiation has been confirmed to the T.38 GW 83 (F104). Then, the T.38 GW 83 having received this request replies ACK to the facsimile apparatus 81 (F105). Thus, the call connection between the apparatuses has been established.

The above-described control is a call control based on the SIP in the G3 FAX connected to the T.38 via the T.38 GW.

Next, the data transfer is performed as Media Session while following the T.30 protocol between the facsimile apparatus 85 and the T.38 GW 83 where the call connection has been established. Furthermore, data transfers (D85 to D88) are performed as Media Session while following the T.38 protocol between the T.38 GW and the facsimile apparatus 81 where the call connection has been established.

In this manner, when all the data transfers are ended, from the facsimile apparatus 85 to the T.38 GW 83, BYE is issued as a session end request (F106). Then, BYE is issued from the T.38 GW 83 to the facsimile apparatus 81 (F108). The facsimile apparatus 81 having received this request replies OK to the T.38 GW 83 (F109). Then, the T.38 GW 83 replies OK to the facsimile apparatus 85 (F110). Thus, the call is disconnected to end the T.38 communication and the T.30 communication.

As described above, as illustrated in FIG. 7, the limit values of the T.38 communications and the T.30 communications are respectively held in the form of the limit value of the concurrent communication number of the entirety of the T.38 communications and the T.30 communications.

To be more specific, the limit value of the concurrent communication number of the T.38 communication capable facsimile apparatuses alone, the limit value of the concurrent communication number with the T.30 communication capable facsimile apparatuses via the T.38 GW, and the limit value of the concurrent communication number of the entirety of the T.38 communications and the T.30 communications are respectively held.

Then, in a case where a plurality of communications are concurrently performed via the network, if a new session initiation request is issued, the determination as to whether the new incoming call is accepted is made depending on whether the three limit values of the concurrent communication numbers are reached. To be more specific, depending on whether the communication number of the T.38 communication capable facsimile apparatuses alone, the communication number with the T.30 communication capable facsimile apparatuses via the T.38 GW, and a summation of the communication numbers reaches the above-described three limit values of the concurrent communication numbers, the determination as to whether the new incoming call is accepted is made.

In this way, according to the present embodiment, the determination as to whether the transmission origin is the T.38 communication capable facsimile apparatus or the communication number with the T.30 communication capable facsimile apparatus via the T.38 GW is made based on the new incoming call information (Invite signal). Then, in a case where the number of the concurrent communications already performed reaches the determined limit value or a case where the summation reaches the limit value, as the concurrent communication equal to or more than the limit value cannot be performed, the new incoming call is not accepted and BUSY or Disconnect is returned. It is noted that the communication request of this new incoming call can also be issued again after the same type of the communication as the incoming call is ended.

According to the present embodiment, in a case where the concurrent communication number with the T.30 communication capable facsimile apparatuses via the T.38 GW reaches the limit value, the control is performed so as to reject the incoming call from the T.30 communication capable facsimile apparatus via the new T.38 GW. As a result, it is possible to attain the stable communication condition without causing communication errors.

### Second Exemplary Embodiment

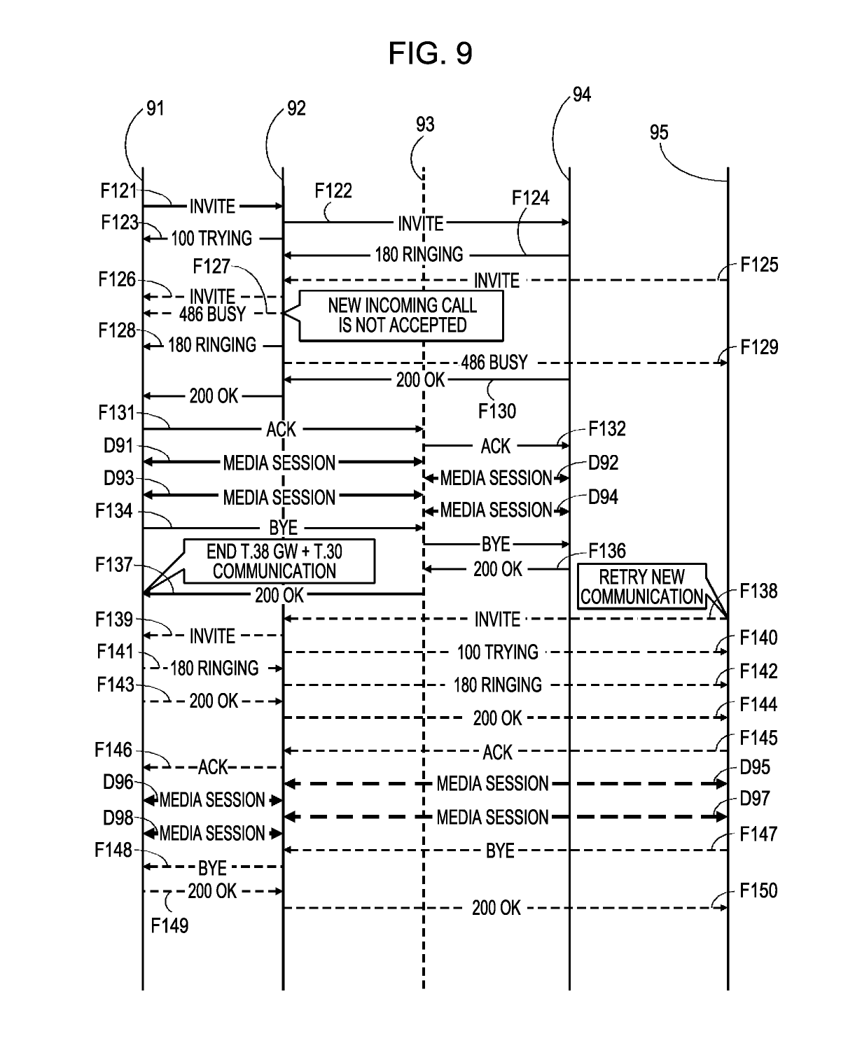

According to the above-described first exemplary embodiment, the T.38 apparatus has a user mode with which the above-described the concurrent communication limit numbers illustrated in FIG. 7 can be set and the above-described determination on the new session initiation request illustrated in FIG. 6 has the routine. Then, the description has been provided of the case in which when the concurrent communication number with the T.30 communication capable facsimile apparatuses via the T.38 GW reaches the limit value, the new session initiation request is issued from the T.30 communication capable facsimile apparatuses via the T.38 GW. Hereinafter, a description will be provided of an embodiment in which the concurrent communication number of the entirety of the T.38 communications and the T.30 communications which are currently in communications reaches the limit value with reference to FIG. 9.

According to the present embodiment, the concurrent communication limit numbers illustrated in FIG. 7 are set in advance as follows. The “Concurrent communication limit number of T.38 communication capable facsimile apparatuses alone” is set as “10”, the “Concurrent communication number with the T.30 communication capable facsimile apparatuses via the T.38 GW” is set as “3”, and the “Concurrent communication limit number of entirety of T.38 communications and T.30 communications” is set as “13”. Then, a description will be provided of a case in which while the concurrent communication number of the T.38 communication capable facsimile apparatuses alone does not reach the limit value “10” yet but the concurrent communication number of the entirety of the T.38 communications and the T.30 communications already reaches the limit value “13”, the new session initiation request from the T.38 communication capable facsimile apparatus.

FIG. 9 is a diagram for describing a second communication phase example in the image forming apparatus to which the data communication apparatus according to the present embodiment is applied. According to this example, a description will be provided of a case in which SIP servers of facsimile apparatuses 94 and 95 are omitted for simplicity, and only a single T.38 GW 93 is provided as the T.38 GW. It is noted that facsimile apparatuses 91 and 95 are the T.38 communication capable facsimile apparatuses, but may also be composed of information processing apparatuses having other communication control functions. The facsimile apparatus 94 is the T.30 communication capable facsimile apparatus but may also be composed of an information processing apparatus having other communication control functions.

First, from the facsimile apparatus 91 to a SIP server 92, INVITE is issued as a session initiation request and an outgoing call is started (F121). The SIP server 92 of the facsimile apparatus 91 having received this request issues INVITE to a SIP server (not illustrated) of the facsimile apparatus 94. Along with this, a reply to the facsimile apparatus 91 is required within a predetermined time, and TRYING as an interim reply is returned to the facsimile apparatus 91 (F123).

The SIP server (not illustrated) of the facsimile apparatus 94 having received INVITE from the SIP server 92 of the facsimile apparatus 91 issues INVITE via the facsimile apparatus 93 to the facsimile apparatus 94 while following the T.30 protocol (F122). Along with this, TRYING as an interim reply is returned to the SIP server 92 of the facsimile apparatus 91.

In this manner, the facsimile apparatus 94 having received INVITE from the SIP server (not illustrated) of the facsimile apparatus 94 via the T.38 GW 93 plays a ringing tone to the SIP server (not illustrated) of the facsimile apparatus 94 when a reply can be made. Then, RINGING is retuned via the facsimile apparatus 93 (F124). The SIP server (not illustrated) of the facsimile apparatus 94 having received this reply via the T.38 GW 93 returns RINGING to the SIP server 92 of the facsimile apparatus 91.

At this stage, from the facsimile apparatus 95 to a SIP server (not illustrated) of the facsimile apparatus 95, INVITE is issued as a new session initiation request and an outgoing call is started while following the T.38 protocol. Then, the SIP server (not illustrated) of the facsimile apparatus 95 having received INVITE from the facsimile apparatus 95 issues INVITE to the SIP server 92 of the facsimile apparatus 91 (F125).

In this manner, the SIP server 92 of the facsimile apparatus 91 having received INVITE from the SIP server (not illustrated) of the facsimile apparatus 95 issues INVITE to the facsimile apparatus 91 (F126).

According to the situation of he facsimile apparatus 91 having received INVITE from the SIP server 92 of the facsimile apparatus 91, the concurrent communication number of the T.38 communication capable facsimile apparatuses alone does not reach the limit value “10” yet but the concurrent communication number of the entirety of the T.38 communications and the T.30 communications already reaches the limit value “13”.

For this reason, based on the above-described determination in the flowchart of FIG. 6, the session initiation request is not accepted from the facsimile apparatus 95. For this reason, Busy is returned to the SIP server 92 of the facsimile apparatus 91 (F127) to reject the new incoming call.

In this manner, the SIP server 92 of the facsimile apparatus 91 having received Busy from the facsimile apparatus 91 issues Busy to the SIP server of the facsimile apparatus 95 (not illustrated) (F129).

In this manner, the SIP server (not illustrated) of the facsimile apparatus 95 having received Busy from the SIP server 92 of the facsimile apparatus 91 issues Busy to the facsimile apparatus 95. With this configuration, the new session initiation request of the T.38 communication capable facsimile apparatuses alone is not accepted, only the communications which already initiated are continued.

That is, the SIP server 92 of the facsimile apparatus 91 having received RINGING from the SIP server (not illustrated) of the facsimile apparatus 94 returns RINGING to the facsimile apparatus 91 (F128).

In parallel to this reply of RINGING, when a reply can be made at the G3 FAX, as the request is success, the facsimile apparatus 94 returns OK via a T.38 GW 93 to the SIP server (not illustrated) of the facsimile apparatus 94.

The SIP server (not illustrated) of the facsimile apparatus 94 having received this reply via the T.38 GW 93 returns OK to the SIP server 92 of the facsimile apparatus 91 (F130). The SIP server 92 of the facsimile apparatus 91 having received this reply returns OK to the facsimile apparatus 91 (F130).

The facsimile apparatus 91 having received this reply replies ACK informing that the session initiation has been confirmed to the SIP server (not illustrated) of the facsimile apparatus 94. The SIP server (not illustrated) of the facsimile apparatus 94 having received this request replies ACK to the T.38 GW 93 (F131). The T.38 GW 93 having received this request replies ACK to the facsimile apparatus 94 (F132). Thus, the call connection between the apparatuses has been established.

The above-described control is a call control based on the SIP with respect to the T.30 communication capable facsimile apparatus connected via the T.38 GW 93.

Next, the data transfer is performed as Media Session while following the T.38 protocol between the facsimile apparatus 91 and the T.38 GW 93 where the call connection has been established. Furthermore, data transfers (D91 to D94) are performed as Media Session while following the T.30 protocol between the facsimile apparatus 94 and the T.38 GW 93 where the call connection has been established.

When all the data transfers are ended, from the facsimile apparatus 91 to the GW 93, BYE is issued as a session end request (F134). Then, BYE is issued from the GW 93 to the facsimile apparatus 94 (G3 FAX) (F135). The facsimile apparatus 94 (the G3 FAX) having received this request replies OK to the T.38 GW 93 (F136), and then the T.38 GW 93 replies OK to the facsimile apparatus 91 (F137). Thus, the call is disconnected to end the T.38 communication and the T.30 communication.

With this configuration, the concurrent communication number of the entirety of the T.38 communications and the T.30 communications is changed from the limit value “13” to “12”, and therefore the new communication from the facsimile apparatus 94 can be concurrently accepted.

In this situation, from the facsimile apparatus 95 to the SIP server (not illustrated) of the facsimile apparatus 95, INVITE is issued again as a new session initiation request and an outgoing call is started while following the T.38 protocol. Then, the SIP server (not illustrated) of the facsimile apparatus 95 having received INVITE from the facsimile apparatus 95 issues INVITE to the SIP server 92 of the facsimile apparatus 91 (F138). Along with this, a reply to the facsimile apparatus 95 is required within a predetermined time, and TRYING as an interim reply is returned to the facsimile apparatus 95.

In this manner, the SIP server 92 of the facsimile apparatus 95 having received INVITE from the SIP server (not illustrated) of the facsimile apparatus 95 issues INVITE to the facsimile apparatus 81 (F139). Along with this, TRYING as an interim reply is returned to the SIP server of the facsimile apparatus 95 (F140).

The facsimile apparatus 91 having received INVITE from the SIP server 92 of the facsimile apparatus 91 plays a ringing tone and returns RINGING to the SIP server 92 of the facsimile apparatus 91 based on the determination of the flowchart illustrated in FIG. 6 when a reply can be made (F141).

The SIP server 92 of the facsimile apparatus 91 having received this reply returns RINGING to the SIP server (not illustrated) of the facsimile apparatus 95. The SIP server (not illustrated) of the facsimile apparatus 95 having received this reply returns RINGING to the facsimile apparatus 95 (F142). In parallel to this reply of RINGING, when a reply can be made, as the request is success, the facsimile apparatus 91 returns OK to the SIP server 92 of the facsimile apparatus 91 (F143). The SIP server 92 of the facsimile apparatus 91 having received this reply returns OK to the SIP server (not illustrated) of the facsimile apparatus 95. The SIP server (not illustrated) of the facsimile apparatus 95 having received this reply returns OK to the facsimile apparatus 95 (F144). The facsimile apparatus 95 having received this reply replies ACK informing that the session initiation has been confirmed to the facsimile apparatus 91 (F145, F146). Thus, the call connection between the apparatuses has been established. The above-described control is a call control based on the SIP in a case in which the T.38 communication capable facsimile apparatuses alone are connected to each other.

Next, data transfers D95 to D98 are performed as Media Session while following the T.38 protocol between the facsimile apparatus 95 and the facsimile apparatus 91 where the call connection has been established.

In this manner, when all the data transfers are ended, BYE is issued from the facsimile apparatus 95 to the facsimile apparatus 91 (F147, F148). The facsimile apparatus 91 having received this request replies OK to the facsimile apparatus 95 (F149, F150), and the call is disconnected to end the T.38 communication.

As described above, as illustrated in FIG. 8, the limit values are respectively held in the form of the limit value of the concurrent communication number of the entirety of the T.38 communications and the T.30 communications.

To be more specific, the variable concurrent communication number limit based on the T.38 protocol holds the limit value of the concurrent communication number of the T.38 communication capable facsimile apparatuses alone, the limit value of the concurrent communication number of the T.30 communication capable facsimile apparatuses via the T.38 GW, and the limit value of the concurrent communication number of the entirety of the T.38 communications and the T.30 communications, respectively.

Then, in a case where a plurality of communications are concurrently performed via the network, if a new session initiation request is issued, the determination as to whether the new incoming call is accepted is made depending on whether the three limit values of the concurrent communication numbers are reached.

To be more specific, the determination as to whether the transmission origin is the T.38 communication capable facsimile apparatus or the communication number with the T.30 communication capable facsimile apparatus via the T.38 GW is made based on the new incoming call information (Invite signal). Then, in a case where the number of the concurrent communications already performed reaches the determined limit value or a case where the summation reaches the limit value, as the concurrent communication equal to or more than the limit value cannot be performed, the new incoming call is not accepted and BUSY or Disconnect is returned. It is noted that the communication request of this new incoming call can also be issued again after the same type of the communication as the incoming call is ended.

According to the present embodiment, in a case where the total concurrent communication limit number is reached of the T.30 communications via the T.38 GW, a new incoming call is not accepted from the T.38 communication capable facsimile apparatus. As a result, it is possible to attain the stable communication condition without causing communication errors.

### Third Exemplary Embodiment

According to the above-described first and second exemplary embodiments, the T.38 communication capable facsimile apparatus has a user mode with which the above-described the concurrent communication limit numbers illustrated in FIG. 7 can be set and the above-described determination on the new session initiation request illustrated in FIG. 6 has the routine. Then, the description has been provided of the case in which when the concurrent communication number with the T.30 communication capable facsimile apparatuses via the T.38 GW reaches the limit value, a new session initiation request from the T.30 communication capable facsimile apparatus via the T.38 GW or the T.38 communication capable facsimile apparatus.

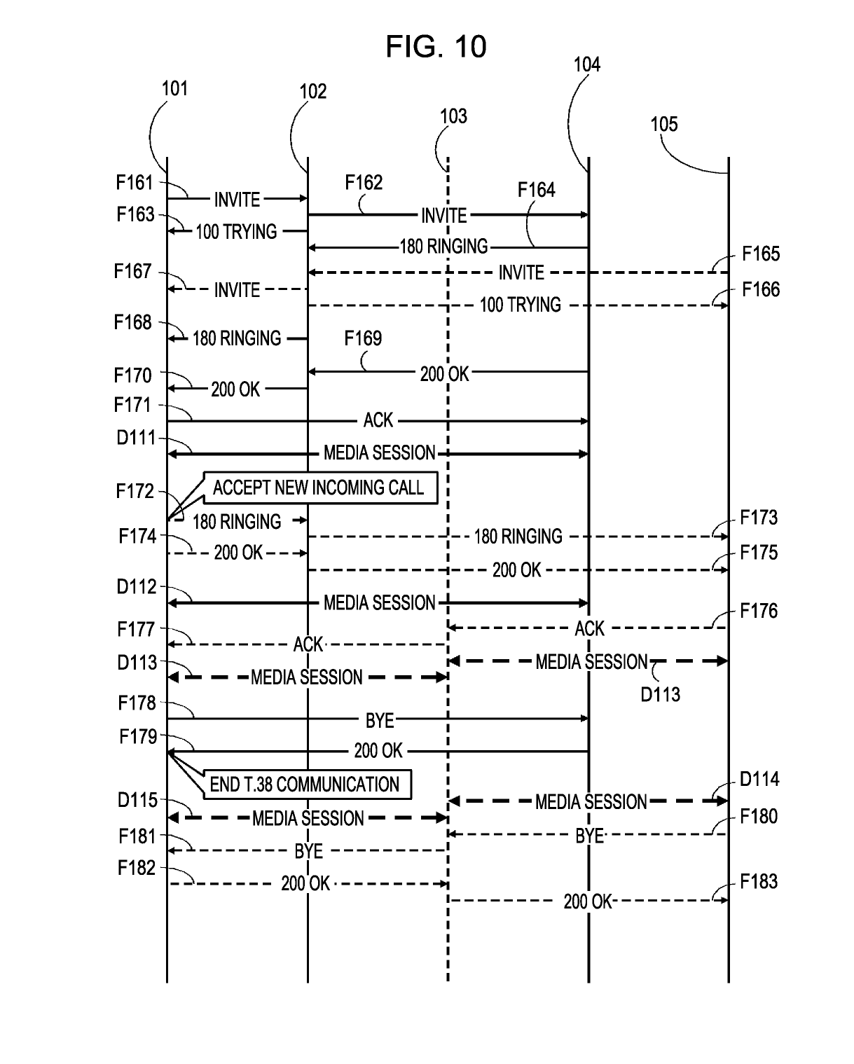

Hereinafter, a description will be provided of an embodiment in which the concurrent communication number of the T.38 communication capable facsimile apparatuses alone which are currently in communications reaches the limit value but the concurrent communication number with the T.30 communication capable facsimile apparatuses via the T.38 GW does not reach the limit value with reference to FIG. 10.

FIG. 10 is a diagram for describing a third communication phase example in the image forming apparatus to which the data communication apparatus according to the present embodiment is applied. According to this example, the above-described the concurrent communication limit numbers illustrated in FIG. 7 are previously set in the following manner. The “Concurrent communication limit number of T.38 communication capable facsimile apparatuses alone” is set as “10”, the “Concurrent communication number with T.30 communication capable facsimile apparatuses via T.38 GW” is set as “3”, and the “Concurrent communication limit number of entirety of T.38 communications and T.30 communications” is set as “13”. Then, the situation is as follows. The concurrent communication number of the T.38 communication capable facsimile apparatuses alone already reaches the limit value “10” but the concurrent communication number with the T.30 communication capable facsimile apparatuses via the T.38 GW does not reach the limit value “3”. Then, a description will be provided of a case in which the new session initiation request is issued from the T.30 communication capable facsimile apparatuses via the T.38 GW.

In addition, for simplicity, in FIG. 10, SIP servers of facsimile apparatuses 104 and 105 are omitted, and a single T.38 GW 103 is provided as the T.38 GW.

First, from a facsimile apparatus 101 to a SIP server 102 of the facsimile apparatus 101, INVITE is issued as a session initiation request (F161) and an outgoing call is started. The SIP server 102 of the facsimile apparatus 101 having received this request issues INVITE to a SIP server (not illustrated) of the facsimile apparatus 104 (F162). Along with this, a reply to the facsimile apparatus 101 is required within a predetermined time, and TRYING as an interim reply is returned to the facsimile apparatus 101 (F163).

The SIP server of the facsimile apparatus 104 having received INVITE from the SIP server 102 of the facsimile apparatus 101 issues INVITE to the facsimile apparatus 104 and TRYING as an interim reply is returned to the SIP server 102 of the facsimile apparatus 101.

In this manner, the facsimile apparatus 104 having received INVITE from the SIP server (not illustrated) of the facsimile apparatus 104 plays a ringing tone and return RINGING to the SIP server (not illustrated) of the facsimile apparatus 104 when a reply can be made. The SIP server (not illustrated) of the facsimile apparatus 104 having received this reply returns RINGING to the SIP server 102 of the facsimile apparatus 101 (F164).

At this stage, INVITE is issued from the facsimile apparatus 105 via the T.38 GW 103 to a SIP server (not illustrated) of the facsimile apparatus 105 as a new session initiation request and an outgoing call is started while following the T.30 protocol.

Then, the SIP server (not illustrated) of the facsimile apparatus 105 receives INVITE based on the T.30 protocol via the T.38 GW 103 from the facsimile apparatus 105.

After that, the SIP server (not illustrated) of the facsimile apparatus 105 having received INVITE based on the T.30 protocol via the T.38 GW 103 issues INVITE to the SIP server 102 of the facsimile apparatus 101 while following the T.38 protocol (F165). Along with this a reply to the facsimile apparatus 105 is required within a predetermined time, and TRYING as an interim reply is returned to the facsimile apparatus 105 (F166).

In this manner, the SIP server 102 of the facsimile apparatus 101 having received INVITE from the SIP server (not illustrated) of the facsimile apparatus 105 issues INVITE to the facsimile apparatus (T.38) 101 (F167). Along with this, TRYING as an interim reply is returned to the SIP server (not illustrated) of the facsimile apparatus 105.

In this situation, according to the communication condition between the facsimile apparatus 101 and the facsimile apparatus 104, the SIP server 102 of the facsimile apparatus 101 having received the reply RINGING from the facsimile apparatus 104 returns RINGING to the facsimile apparatus 101 (F168).

In parallel to this reply of RINGING, when a reply can be made at the facsimile apparatus 104, as the request is success, OK is returned to the SIP server (not illustrated) of the facsimile apparatus 104. The SIP server (not illustrated) of the facsimile apparatus 104 having received this reply returns OK to the SIP server 102 of the facsimile apparatus 101 (F169).

The SIP server 102 of the facsimile apparatus 101 having received this reply returns OK to the facsimile apparatus 101 (F170). The facsimile apparatus 101 having received this reply replies ACK informing that the session initiation has been confirmed to the facsimile apparatus 104 (F171). Thus, the call connection between the apparatuses has been established. The above-described control is a call control based on the SIP in the T.38.

Next, data transfer D111 is performed as Media Session while following the T.38 protocol between the facsimile apparatus 101 and the facsimile apparatus 104a where the call connection has been established.

On the other hand, according to the communication situation between the facsimile apparatus 105 and the facsimile apparatus 101, in the facsimile apparatus 101 having received INVITE from the SIP server 102 of the facsimile apparatus 101, the concurrent communication number of the T.38 communication capable facsimile apparatuses alone already reaches the limit value “10”. However, the concurrent communication number with the T.30 communication capable facsimile apparatus via the T.38 GW 103 does not reach the limit value “3”.

For this reason, based on the above-described determination in the flowchart of FIG. 6, as the session initiation request from the facsimile apparatus 105 can be accepted, the reply can be made. Then, a ringing tone is played and RINGING is returned to the SIP server 102 of the facsimile apparatus 101 (F172).

The SIP server 102 of the facsimile apparatus 101 having received this reply returns RINGING to the SIP server (not illustrated) of the facsimile apparatus 105. The SIP server (not illustrated) of the facsimile apparatus 105 having received this reply returns RINGING to the facsimile apparatus 105 via the T.38 GW 103 (F173).

In parallel to this reply of RINGING, when a reply can be made via the T.38 GW 103 to the G3 FAX, as the request is success, the facsimile apparatus 101 returns OK to the SIP server 102 of the facsimile apparatus 101 (F174). The SIP server 102 of the facsimile apparatus 101 having received this reply returns OK to the SIP server (not illustrated) of the facsimile apparatus 105. The SIP server (not illustrated) of the facsimile apparatus 105 having received this reply returns OK via the T.38 GW 103 to the facsimile apparatus 105 (F175).

Herein, according to the communication situation between the facsimile apparatus 101 and the facsimile apparatus 104, a data transfer D112 is performed as final Media Session.

On the other hand, according to the communication situation between the facsimile apparatus 105 and the facsimile apparatus 101, the facsimile apparatus 105 receives OK from the SIP server (not illustrated) of the facsimile apparatus 105 via the T.38 GW 103. Then, the facsimile apparatus 105 replies ACK informing that the session initiation has been confirmed to the T.38 GW 103 (F176). The T.38 GW 103 having received this reply replies ACK to the facsimile apparatus 101 (F177). Thus, the call connection between the apparatuses has been established.

The above-described control is a call control based on the SIP in communication capable facsimile apparatus connected via the T.38 GW.

Next, the data transfer D112 is performed as Media Session while following the T.30 protocol between the facsimile apparatus 105 and the T.38 GW 103 where the call connection has been established.

Furthermore, a data transfer D113 is performed as Media Session while following the T.38 protocol between the T.38 GW 103 and the facsimile apparatus 101 where the call connection has been established.

At this time, according to the communication situation between the facsimile apparatus 101 and the facsimile apparatus 104, when all the data transfers are ended. Therefore, from the facsimile apparatus 101 to the facsimile apparatus 104, BYE is issued as a session end request (F178). The reception apparatus having received this reply replies OK (F179). Thus, the call is disconnected to end the communication based on the T.38 protocol.

On the other hand, according to the communication situation between the facsimile apparatus 105 and the facsimile apparatus 101, data transfers D114 and D115 are performed as final Media Session.

In this manner, when all the data transfers are ended, from the facsimile apparatus 105 to the T.38 GW 103, BYE is issued as a session end request (F180). Then, BYE is issued from the T.38 GW 103 to the facsimile apparatus 101 (F181). The facsimile apparatus 101 having received this request replies OK to the T.38 GW 103 (F182). Then, the T.38 GW 103 replies OK to the facsimile apparatus 105 (F183). Thus, the call is disconnected to end the T.38 communication and the T.30 communication.

As described above, as illustrated in FIG. 10, the limit values are respectively held as the form of the limit value of the concurrent communication number of the entirety of the T.38 communications and the T.30 communications.

To be more specific, the limit value of the concurrent communication number of the T.38 communication capable facsimile apparatuses alone, the limit value of the concurrent communication number with the T.30 communication capable facsimile apparatuses via the T.38 GW, and the limit value of the concurrent communication number of the entirety of the T.38 communications and the T.30 communications are respectively held.

Then, in a case where a plurality of communications are concurrently performed via the network, if a new session initiation request is issued, the determination as to whether the new incoming call is accepted is made depending on whether the three limit values of the concurrent communication numbers are reached.

To be more specific, the determination as to whether the transmission origin is the T.38 communication capable facsimile apparatus or the communication number with the T.30 communication capable facsimile apparatus via the T.38 GW is made based on the new incoming call information (Invite signal). Then, in a case where the number of the concurrent communications already performed reaches the determined limit value or a case where the summation reaches the limit value, as the concurrent communication equal to or more than the limit value cannot be performed, the new incoming call is not accepted and BUSY or Disconnect is returned. It is noted that the communication request of this new incoming call can also be issued again after the same type of the communication as the incoming call is ended.

According to the present embodiment, even in the case where the concurrent communication limit number of the T.38 communication capable facsimile apparatuses alone is reached, if the concurrent communication limit number with the T.30 communication capable facsimile apparatuses via the T.38 GW is not reached, the new incoming call is accepted. As a result, it is possible to attain the stable communication condition without causing communication errors. Fourth Exemplary Embodiment

According to the above-described first and second exemplary embodiments, the T.38 communication capable facsimile apparatus has a user mode with which the above-described the concurrent communication limit numbers illustrated in FIG. 7 can be set and the above-described determination on the new session initiation request illustrated in FIG. 6 has the routine. Then, the description has been provided of the case in which when the concurrent communication number with the T.30 communication capable facsimile apparatuses via the T.38 GW reaches the limit value, the new session initiation request is issued from the T.30 communication capable facsimile apparatus via the T.38 GW or the T.38 communication capable facsimile apparatus.

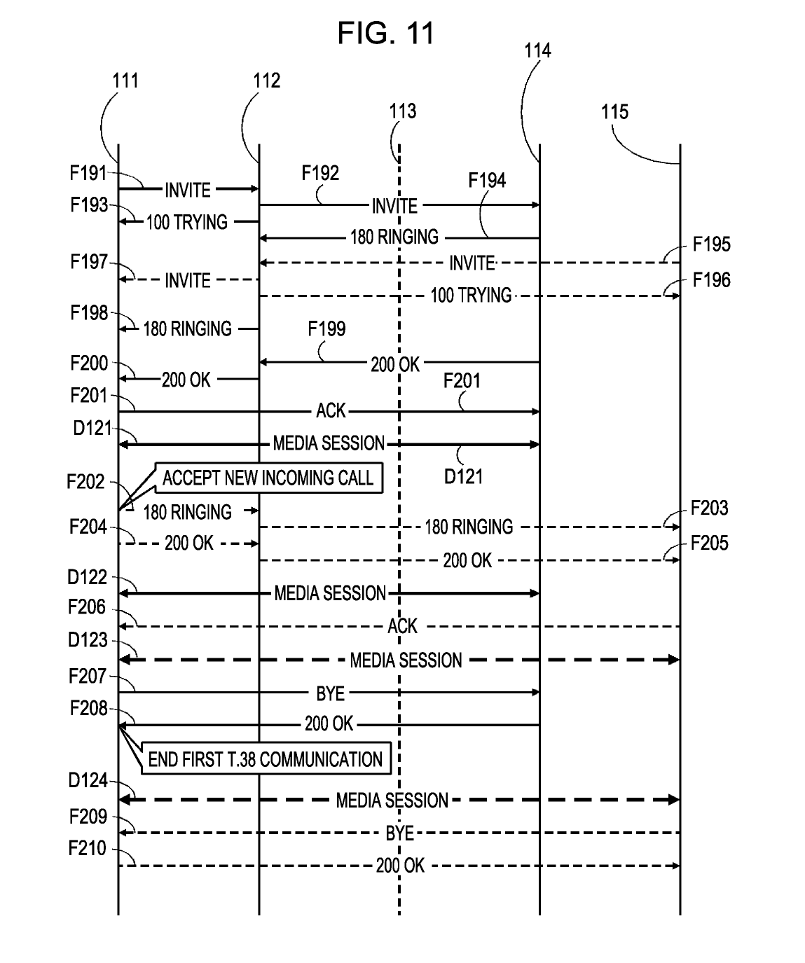

In other words, the description has been provided of the case in which the concurrent communication number of the T.38 communication capable facsimile apparatuses alone which are currently in communications reaches the limit value, but the concurrent communication number with the T.30 communication capable facsimile apparatuses via the T.38 GW does not reach the limit value. Hereinafter, an embodiment in which the concurrent communication number of the T.38 communication capable facsimile apparatuses alone which are currently in communications does not reach the limit value yet will be described with reference to FIG. 11.

FIG. 11 is a diagram for describing a fourth communication phase example in the image forming apparatus to which the data communication apparatus according to the present embodiment is applied.

According to this example, the above-described the concurrent communication limit numbers illustrated in FIG. 7 are previously set in the following manner.

To be more specific, the “Concurrent communication limit number of T.38 communication capable facsimile apparatuses alone” is set as “10”, the “Concurrent communication number with T.30 communication capable facsimile apparatuses via T.38 GW” is set as “3”, and the “Concurrent communication limit number of entirety of T.38 communications and T.30 communications” is set as “13”. Also, a description will be provided of a case in which while the concurrent communication number of the T.38 communication capable facsimile apparatuses alone does not reach the limit value “10” yet, the new session initiation request is issued from the T.38 communication capable facsimile apparatus.

In addition, for simplicity, in FIG. 11, SIP servers of facsimile apparatuses 114 and 115 are omitted, and only a single T.38 GW 113 is provided as the T.38 GW.

First, from a facsimile apparatus 111 to a SIP server 112 of the facsimile apparatus 111, INVITE is issued as a session initiation request and an outgoing call is started (F191). The SIP server 112 of the facsimile apparatus 111 having received this request issues INVITE to a SIP server (not illustrated) of the facsimile apparatus 114 (F192). Along with this, a reply to the facsimile apparatus 111 is required within a predetermined time, and TRYING as an interim reply is returned to the facsimile apparatus 111 (F193).

Then, the SIP server of the facsimile apparatus 114 having received INVITE from the SIP server 112 of the facsimile apparatus 111 issues INVITE to the facsimile apparatus 114. Along with this, TRYING as an interim reply is returned to the SIP server of the facsimile apparatus 111.

The facsimile apparatus 114 having received INVITE from the SIP server (not illustrated) of the facsimile apparatus 114 plays a ringing tone and returns RINGING to the SIP server (not illustrated) of the facsimile apparatus 114 when a reply can be made. The SIP server (not illustrated) of the facsimile apparatus 114 having received this reply returns RINGING to the SIP server 112 of the facsimile apparatus 111 (F194).

At this stage, INVITE is issued from the facsimile apparatus 115 to a SIP server (not illustrated) of the facsimile apparatus 115 as a new session initiation request and an outgoing call is started while following the T.38 protocol. Then, the SIP server (not illustrated) of the facsimile apparatus 115 having received INVITE from the facsimile apparatus 115 issues INVITE to the SIP server 112 of the facsimile apparatus 111 (F195). Along with this, a reply to the facsimile apparatus 115 a reply to the transmission apparatus 51, and TRYING as an interim reply is returned to the facsimile apparatus 115 (F196).

In this manner, the SIP server 112 of the facsimile apparatus 111 having received INVITE from the SIP server (not illustrated) of the facsimile apparatus 115 issues INVITE to the facsimile apparatus 111 (T.38) (F197). Along with this, TRYING as an interim reply is returned to the SIP server (not illustrated) of the facsimile apparatus 115.

In this situation, according to the communication situation between the facsimile apparatus 111 and the facsimile apparatus 114, the SIP server 112 of the facsimile apparatus 111 having received the reply RINGING from the facsimile apparatus 114 returns RINGING to the facsimile apparatus 111 (F198).

In parallel to this reply of RINGING, when a reply can be made at the facsimile apparatus 114, as the request is success, OK is returned to the SIP server (not illustrated) of the facsimile apparatus 114. The SIP server (not illustrated) of the facsimile apparatus 114 having received this reply returns OK to the SIP server 112 of the facsimile apparatus 111 (F199).

The SIP server 112 of the facsimile apparatus 111 having received this reply returns OK to the facsimile apparatus 111 (T.38) (F200). The facsimile apparatus 111 (T.38) having received this reply replies ACK informing that the session initiation has been confirmed to the SIP server 112 (T.38) (F201). Thus, the call connection between the apparatuses has been established. The above-described control is a call control the based on SIP in the T.38.

Next, a data transfer D121 is performed as Media Session while following the T.38 protocol between the facsimile apparatus 111 and the facsimile apparatus 114 where the call connection has been established.

On the other hand, according to the communication situation between the facsimile apparatus 115 and the facsimile apparatus 111, in the facsimile apparatus 111 having received INVITE from the SIP server 112 of the facsimile apparatus 111, the concurrent communication number of the T.38 communication capable facsimile apparatuses alone does not reach the limit value “10”. For this reason, based on the above-described determination in the flowchart of FIG. 6, the session initiation request can be accepted from the facsimile apparatus 115 and thus the reply can be made. In this situation, a ringing tone is played and RINGING is returned to the SIP server 112 of the facsimile apparatus 111 (F202). The SIP server 112 of the facsimile apparatus 111 having received this reply returns RINGING to the SIP server (not illustrated) of the facsimile apparatus 115 (F203).

The SIP server (not illustrated) of the facsimile apparatus 115 having received this reply returns RINGING to the facsimile apparatus 115. In parallel to this reply of RINGING, when a reply can be made in the T.38, as the request is success, the facsimile apparatus 111 returns OK to the SIP server 112 of the facsimile apparatus 111 (F204). The SIP server 112 of the facsimile apparatus 111 having received this reply returns OK to the SIP server (not illustrated) of the facsimile apparatus 115 (F205). The SIP server (not illustrated) of the facsimile apparatus 115 having received this reply returns OK to the facsimile apparatus 111.

At this time, according to the communication situation between the facsimile apparatus 111 and the facsimile apparatus 114, a data transfer D122 is performed as final Media Session.

On the other hand, according to the communication situation between the facsimile apparatus 115 and the facsimile apparatus 111, the facsimile apparatus 115 receives the reply OK from the SIP server (not illustrated) of the facsimile apparatus 115. Then, the facsimile apparatus 115 having received the reply OK replies ACK informing that the session initiation has been confirmed to the facsimile apparatus 111 (F206). Thus, the call connection between the apparatuses has been established. The above-described control is a call control based on the SIP in the T.38.

Next, a data transfer D123 is performed as Media Session while following the T.38 protocol between the facsimile apparatus 115 and the facsimile apparatus 111 where the call connection has been established.

Herein, according to the communication situation between the facsimile apparatus 111 and the facsimile apparatus 114, all the data transfers are ended. Therefore, from the facsimile apparatus 111 to the facsimile apparatus 114, BYE is issued as a session end request (F207). The reception apparatus having received this reply replies OK (F208). Thus, the call is disconnected to end the communication based on the T.38 protocol.

On the other hand, according to the communication situation between the facsimile apparatus 115 and the facsimile apparatus 111, a data transfer D124 is performed as final Media Session.

In this manner, when all the data transfers are ended, BYE is issued from the facsimile apparatus 115 to the facsimile apparatus 111 (F209). The facsimile apparatus 111 having received this request replies OK (F210). Thus, the call is disconnected to end the communication based on the T.38 protocol.

As described above, as illustrated in FIG. 11, the limit values are respectively held in the form of the limit value of the concurrent communication number of the entirety of the T.38 communications and the T.30 communications.

To be more specific, the limit value of the concurrent communication number of the T.38 communication capable facsimile apparatuses alone, the limit value of the concurrent communication number with the T.30 communication capable facsimile apparatuses via the T.38 GW, and the limit value of the concurrent communication number of the entirety of the T.38 communications and the T.30 communications are respectively held.

Then, in a case where a plurality of communications are concurrently performed via the network, if a new session initiation request is issued, the determination as to whether the new incoming call is accepted is made depending on whether the three limit values of the concurrent communication numbers are reached.

To be more specific, the determination as to whether the transmission origin is the T.38 communication capable facsimile apparatus or the communication number with the T.30 communication capable facsimile apparatus via the T.38 GW is made based on the new incoming call information (Invite signal). Then, in a case where the number of the concurrent communications already performed reaches the determined limit value or a case where the summation reaches the limit value, as the concurrent communication equal to or more than the limit value cannot be performed, the new incoming call is not accepted and BUSY or Disconnect is returned. The communication request of this new incoming call can also be issued again after the same type of the communication as the incoming call is ended.

With this configuration, in a case where the number of the concurrent communications of the T.38 communication capable facsimile apparatuses alone does not reach the concurrent communication limit number, the new incoming call is accepted. As a result, it is possible to attain the stable communication condition without causing communication errors.

### Fifth Exemplary Embodiment

According to the above-described respective exemplary embodiments, a first limit value for limiting the number of the concurrent communications related to the communications with the T.30 communication capable facsimile apparatuses via the T.38 GW is set. Then, a second limit value for limiting the number of the concurrent communications related to the communications with the T.38 communication capable facsimile apparatuses is set. Furthermore, a third limit value for limiting the number of the concurrent communications related to the communications with the T.30 communication capable facsimile apparatuses and the communications with the T.38 communication capable facsimile apparatuses is set. Then, the description has been provided of the case in which the respective numbers of the concurrent communications are limited based on these limit values. However, the usability may be improved by tracking a variation in the communication environment to dynamically change the set respective limit values or by relaxing the limit of the communication request on one side and restricting the communication request on the other side.

### Sixth Exemplary Embodiment

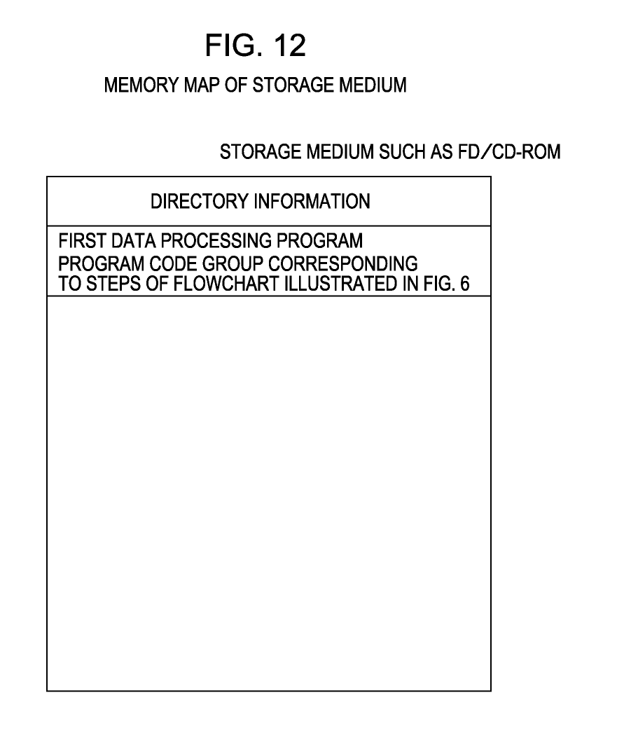

Hereinafter, a configuration of a data processing program which can be read by a data communication apparatus according to an embodiment of the present invention will be described with reference to a memory map illustrated in FIG. 12.

FIG. 12 is a diagram for describing a memory map of a storage medium storing various data processing programs which can be read by the data communication apparatus according to the present embodiment.

It is noted that in particular, although not illustrated in the drawing, information for managing a program group stored in a storage medium, for example, version information, creators, etc., and information relying on an OS or the like on the program reading side, for example, icons for identifying the programs for the display, etc., may also be stored in some cases.

Furthermore, data belonging to the various programs is also managed by the above-described directory. In addition, a program for installing the various programs into the computer, a program for decompressing the program in a case where the program to be installed is compressed, and other programs may also be stored.

The functions illustrated in FIG. 6 according to the present embodiment may be executed by the host computer based on a program installed from outside. In this case, the present invention is also applied to a case where an information group including the program is supplied to an output apparatus through a storage medium such as a CD-ROM, a flash memory, or an FD, or from an external storage medium via the network.

As described above, the storage medium on which a program code of software for realizing the above-described functions according to the embodiments is stored is supplied to a system or an apparatus. The present invention is of course achieved when a computer (or a CPU or an MPU) of the system or the apparatus reads out and executes the program code stored in the storage medium.

In this case, the program code read itself from the storage medium realizes a new function according to the embodiment of the present invention, and the storage medium storing the program code constitutes the embodiment according to the present invention.

Therefore, as long as the functions of the program is provided, any mode of the program may be employed such as an object code, a program executed by an interpreter, and a script data supplied to the OS.

As the storage medium for supplying the program, for example, a flexible disk, a hard disk drive, an optical disk, an opto-magnetic disk, an MO, a CD-ROM, a CD-R, a CD-RW, a magnetic tape, a non-volatile memory card, a ROM, and a DVD can be used.

In this case, the program code itself read from the storage medium realizes the above-described functions according to the embodiment of the present invention, and the storage medium storing the program code constitutes the embodiment according to the present invention.

In addition, as a method of supplying the program, a browser of a client computer is used to establish a connection to a website on the Internet. Then, the supply can be achieved while a computer program itself or a compression file including an automatic install function is downloaded from the website onto a recording medium such as a hard disk drive. Also, the embodiment according to the present invention can also be realized when the program code constituting the program according to the embodiment of the present invention is divided into a plurality of files, and the respective files are downloaded from different websites. In other words, a www server, an ftp server, or the like for allowing a plurality of user to download the program file with which the function processing according to the embodiment of the present invention is realized by the computer is also included in the scope of the present invention.

Moreover, the program according to the embodiment of the present invention is encrypted and stored on a storage medium such as a CD-ROM to be distributed to users. The user who clears a predetermined condition is allowed to download key information for decoding the encryption via the Internet from a website. Then, the key information is used to execute the encrypted program to be installed onto the computer and thus the above-described functions according to the embodiment of the present invention can also be realized.

The above-described functions according to the embodiment of the present invention are realized not only by executing the program code read by the computer. For example, based on an instruction of the program code, an OS (operation system) or the like running on the computer performs all or a part of an actual processing. Such a case is also of course within the scope of the present invention that the above-described functions according to the embodiment of the present invention are realized by the processing.

Furthermore, the program code read from the storage medium is written into a memory which is provided to a function expansion board inserted the computer or a function expansion unit connected to the computer. After that, based on an instruction of the program code, a CPU or the like provided to the function expansion board or the function expansion unit performs all or a part of an actual processing. Such a case is also of course within the scope of the present invention that the above-described functions according to the embodiment of the present invention are realized by the processing.

While the present invention has been described with reference to exemplary embodiments, as is well known to those skilled in the art, it is to be understood that the invention is not limited to the disclosed exemplary embodiments. The scope of the following claims is to be accorded the broadest interpretation so as to encompass all modifications (including organic combinations of the respective exemplary embodiments), equivalent structures and functions.

This application claims the benefit of Japanese Application No. 2006-315451 filed Nov. 22, 2006, which is hereby incorporated by reference herein in its entirety.

What is claimed is:

1. A facsimile apparatus, comprising:
a facsimile communication unit configured to execute at least one of a first facsimile communication which is executed via a first communication path including a public line and a second facsimile communication which is executed via a second communication path that does not include the public line;
a management unit configured to manage limit information indicating a number of communications which can be executed in parallel, the communications including at least one of the first facsimile communication and the second facsimile communication;
an accepting unit configured to accept an initiation request of a new facsimile communication when a facsimile communication is executed by using at least one of the first communication path and the second communication path;
a determination unit configured to determine whether a communication path used for the new facsimile communication is the first communication path or the second communication path; and
a control unit configured to control the facsimile communication unit by determining whether or not to initiate the new facsimile communication based on the limit information managed by the management unit and a determination result of the determination unit.

2. The facsimile apparatus according to claim 1, wherein the first communication path is a communication path including the public line at least and one of a LAN and an Internet, and the first facsimile communication includes a real-time Internet facsimile communication executed via a gateway apparatus and a G3 facsimile communication.

3. The facsimile apparatus according to claim 1, wherein the second communication path is a communication path which does not include the public line but includes at least one of a LAN and an Internet, and the second facsimile communication is a real-time Internet facsimile communication.

4. The facsimile apparatus according to claim 1, wherein the management unit individually manages a first limit information indicating the number of communications related to the first communication communications which can be executed in parallel, a second limit information indicating the number of communications related to the second facsimile communication which can be executed in parallel, and a third limit information indicating the number of communications related to the first facsimile communication and the second facsimile communication which can be executed in parallel.

5. The facsimile apparatus according to claim 4, wherein the first limit information has the number of communications set smaller than the number of communications indicated by the second limit information.

6. The facsimile apparatus according to claim 1, further comprising a setting unit configured to set the limit information managed by the management unit based on an instruction of a user.

7. The facsimile apparatus according to claim 1, wherein the control unit determines, in a case where a total number of communications related to the new facsimile communication and facsimile communications already executed in parallel do not exceed the number indicated by the limit information managed by the management unit, that the new facsimile communication is initiated and instructs the facsimile communication unit to execute the new facsimile communication.

8. The facsimile apparatus according to claim 1, wherein the control unit determines, in a case where a total number of communications including the new facsimile communication exceeds the number indicated by the limit information managed by the management unit, that the new facsimile communication is not initiated and instructs the facsimile communication unit to refuse the new facsimile communication.

9. A control method for a facsimile apparatus which is capable of executing at least one of a first facsimile communication which is executed via a first communication path including a public line and a second facsimile communication which is executed via a second communication path that does not include the public line, the control method comprising:
storing limit information in a storage medium and managing the limit information indicating a number of communications which can be executed in parallel, the communications including at least one of the first facsimile communication and the second facsimile communication;
accepting an initiation request of a new facsimile communication when a facsimile communication is executed by using at least one of the first communication path and the second communication path;
determining whether a communication path used for the new facsimile communication is the first communication path or the second communication path; and
controlling an execution of the facsimile communication by determining whether or not to initiate the new facsimile communication based on the managed limit information and a result of the determination.

10. A computer readable storage medium storing a program for instructing a computer to execute a control method for a facsimile apparatus which is capable of executing at least one of a first facsimile communication which is executed via a first communication path including a public line and a second facsimile communication which is executed via a second communication path that does not include the public line, the control method comprising:
storing limit information in a storage medium and managing the limit information indicating a number of communications which can be executed in parallel, the communications including at least one of the first facsimile communication and the second facsimile communication;
accepting an initiation request of a new facsimile communication when a facsimile communication is executed by using at least one of the first communication path and the second communication path;
determining whether a communication path used for the new facsimile communication is the first communication path or the second communication path; and
controlling an execution of the facsimile communication by determining whether or not to initiate the new facsimile communication based on the managed limit information and a result of the determination.
